(19) United States
(12) Patent Application Publication
(10) Pub. No.: US 2025/0245928 A1
(43) Pub. Date: Jul. 31, 2025

(54) STORAGE MEDIUM, INFORMATION PROCESSING APPARATUS, INFORMATION PROCESSING SYSTEM AND INFORMATION PROCESSING METHOD

(71) Applicant: NINTENDO CO., LTD., Kyoto (JP)

(72) Inventors: Naoto KUBO, Kyoto (JP); Youtarou TOKURIKI, Kyoto (JP)

(21) Appl. No.: 19/037,875

(22) Filed: Jan. 27, 2025

(30) Foreign Application Priority Data
Jan. 30, 2024 (JP) 2024-011594

(51) Int. Cl. G06T 17/20

(52) U.S. Cl. CPC G06T 17/205

(57) ABSTRACT

An example of an information processing system stores voxel data related to a plurality of voxels related to a restorable object, and reference data that serves as a reference for the restorable object, representing a reference value of a parameter included in the voxel data. When a change event has occurred for the restorable object, the information processing system updates the voxel data related to the restorable object. When a restoration condition is satisfied for the restorable object for which the change event has occurred, the information processing system executes a restoration process of gradually changing the restorable object by returning a value of a parameter included in a plurality of voxel data having been updated to the reference value included in the reference data. The information processing system generates a mesh for the restorable object based on the voxel data.

### CROSS REFERENCE TO RELATED APPLICATION

This application claims priority to Japanese Patent Application No. 2024-011594, filed on Jan. 30, 2024, the entire contents of which are incorporated herein by reference.

### FIELD

The present disclosure relates to a storage medium, an information processing system, an information processing apparatus and an information processing method for restoring an object to which a change has been made in a virtual space.

### BACKGROUND AND SUMMARY

A mesh of an object has been generated by using voxel data, for example. It has also been done to make a change, such as deformation, for example, to such an object.

There has been room for improvement in gradually restoring an object to which a change has been made to the unchanged state.

Thus, the present application discloses a storage medium, an information processing apparatus, an information processing system and an information processing method, with which it is possible to gradually restore an object to which a change has been made.

(1)

An example of one or more non-transitory computer-readable storage medium having stored therein instructions that, when executed, cause one or more processors of an information processing apparatus to execute information processing, wherein: the information processing apparatus stores voxel data related to a plurality of voxels related to a restorable object in a virtual space, and reference data that serves as a reference for the restorable object, representing a reference value of a parameter included in the voxel data, and the information processing comprising: when a change event has occurred for the restorable object, updating the voxel data related to the restorable object; when a restoration condition is satisfied for the restorable object for which the change event has occurred, executing a restoration process of gradually changing the restorable object by returning a value of a parameter included in a plurality of voxel data having been updated to the reference value included in the reference data; generating a mesh for the restorable object based on the voxel data; and generating an image of the virtual space including an image obtained by rendering the mesh of the restorable object so as to output the generated image to a display device.

With configuration (1) above, an object to which a change has been made by a change event can be gradually restored by the restoration process.

(2)

The restoration process may be executed when it is determined that the restoration condition is satisfied at a second timing subsequent to a first timing, the second timing being determined based on the first timing at which the change event has occurred.

With configuration (2) above, it is possible to automatically restore a restorable object after the occurrence of a change event.

(3)

The change event may be that a player object is arranged on the restorable object in the virtual space. When the change event occurs, the voxel data may be updated so as to remove a portion of the restorable object that includes a position at which the player object is arranged.

With configuration (3) above, after an object under the feet of the player object is removed, the object is restored, and it is possible to avoid the problem that the player object may run out of places to go as a result of the player continuing to move around, thereby eliminating the object.

(4)

The restoration process may be executed when it is determined that the restoration condition is satisfied in response to an operation by a player.

With configuration (4) above, an object may be restored in response to an operation by the player.

(5)

The reference data may represent the reference value for each of a plurality of voxels related to the restorable object.

With configuration (5) above, it is possible to easily restore the restorable object by the unit of voxels.

(6)

Target voxels to be restored from among the voxels related to the restorable object may be successively designated based on a designation rule so as to restore the designated voxels.

With configuration (6) above, the restorable object can be gradually restored according to a predetermined rule.

(7)

The target voxels may be successively designated along a restoration path set in the virtual space.

With configuration (7) above, the restorable object can be gradually restored in the direction along the determined path.

(8)

The change event may be that a breaker object contacting the restorable object in the virtual space. When the change event occurs, the voxel data may be updated so as to remove a portion of the restorable object that includes a position at which the breaker object made contact. The restoration path may be set, based on a position at which the breaker object contacted the restorable object, so as to extend in a direction in accordance with a contact direction.

With configuration (8) above, restoration can be done along the direction corresponding to the content of the change event (in the example above, the punch direction) at a position corresponding to the contact position.

(9)

When a first restoration condition is satisfied for a portion of the restorable object for which a first change event has occurred as the change event, the target voxels may be successively designated based on first restoration region data defining the restoration path for a first restoration process, which is the restoration process corresponding to the first change event. When a second restoration condition is satisfied for a portion of the restorable object for which a second change event, different from the first change event, has occurred as the change event, the target voxels may be successively designated based on second restoration region data defining the restoration path for a second restoration process, which is the restoration process corresponding to the second change event. During an overlapping period between a period in which the first restoration process is executed and a period in which the second restoration process is executed, restoration may be done for voxels, as the target voxels, that are designated based on at least one of the first restoration region data and the second restoration region data.

With configuration (9) above, even when a plurality of restoration processes are executed in parallel due to a plurality of change events occurring successively, it is possible to reduce the risk of complicating the restoration process.

(10)

A restoration region may be set in the virtual space. The target voxels may be designated from among those of the plurality of voxels related to the restorable object that overlap with the restoration region. The target voxels may be successively designated by moving the restoration region along the restoration path.

With configuration (10) above, it is possible to easily designate target voxels along the path.

(11)

The target voxels may be successively designated in a direction from inside to outside of the restorable object.

With configuration (11) above, it is possible to express how a restorable object gradually restores from the inside.

(12)

The reference data may represent a reference value of a parameter representing density to be used for generating the mesh from among parameters included in the voxel data. When the change event occurs for the restorable object, the voxel data may be updated so as to change the parameter representing density. When a restoration condition is satisfied for the restorable object for which the change event has occurred, the restoration process of gradually changing the restorable object may be executed by returning a value of the parameter representing density included in the voxel data having been updated to the reference value included in the reference data.

With configuration (12) above, it is possible to easily restore the shape of the restorable object that has been deformed by the occurrence of the change event.

(13)

The reference data may represent a reference value for a material set for the voxel from among parameters included in the voxel data. When the change event occurs for the restorable object, the voxel data may be updated so as to change the parameter representing material. When the restoration condition is satisfied for the restorable object for which the change event has occurred, the restoration process of gradually changing the restorable object may be executed by returning a value of the parameter representing material included in the voxel data having been updated to the reference value included in the reference data.

With configuration (13) above, it is possible to easily restore the material of the restorable object whose material has been changed by the occurrence of the change event.

(14)

When the change event occurs for the restorable object, the voxel data related to the restorable object may be updated so as to reduce a range of the virtual space occupied by the restorable object.

With configuration (14) above, it is possible, with the restoration process, to restore the restorable object whose volume has been reduced by the change event.

(15)

When the change event occurs for the restorable object, the range of the virtual space occupied by the restorable object may be reduced, and a separated object corresponding to the reduced portion may be generated. When the restoration condition is satisfied for the restorable object, the restoration process may be executed for the restorable object while the restoration process is not executed for the separated object.

With configuration (15) above, it is possible to reduce the possibility of a problem occurring in the game by executing the restoration process for a restorable object, and it is possible to reduce the processing load of the information processing system by not executing the restoration process for a separated object.

(16)

When the change event occurs for the restorable object, the voxel data related to the restorable object may be updated so as to increase the range of the virtual space occupied by the restorable object.

With configuration (16) above, it is possible, with the restoration process, to restore the restorable object whose volume has been increased by the change event.

(17)

The storage medium may store instructions that cause the information processing apparatus to perform operations further comprising: moving and/or rotating the restorable object in the virtual space by moving and/or rotating a voxel space where the voxel related to the restorable object is set in the virtual space; and when the restorable object is moved and/or rotated after the change event, the restoration process is executed using the voxel data related to the voxel space after the movement and/or rotation.

With configuration (17) above, even if the restorable object is moved and/or rotated, it is possible to reduce the processing load of the information processing system.

Note that the present specification discloses an example of an information processing apparatus (e.g., a terminal device or a server) and an information processing system for executing processes recited in (1) to (17) above. The present specification may also disclose an example of an information processing method (specifically, the game process method) by which the information processing system executes the various processes recited in (1) to (17) above.

With the storage medium, the information processing apparatus, the information processing system and the information processing method set forth above, it is possible to gradually restore an object to which a change has been made.

These and other features, aspects and advantages of the subject matter described herein will become more apparent from the following detailed description of the present invention when taken in conjunction with the accompanying drawings.

### BRIEF DESCRIPTION OF THE DRAWINGS

FIG. 1 is a view showing an example where a non-limiting left controller and a non-limiting right controller are attached to a non-limiting main body apparatus;

FIG. 2 is a view showing an example where a non-limiting left controller and a non-limiting right controller are removed from a non-limiting main body apparatus;

FIG. 3 is a six-sided view showing an example of a non-limiting main body apparatus;

FIG. 4 is a six-sided view showing an example of a non-limiting left controller;

FIG. 5 is a six-sided view showing an example of a non-limiting right controller;

FIG. 6 is a block diagram showing an example of an internal configuration of a non-limiting main body apparatus;

FIG. 7 is a block diagram showing an example of an internal configuration of a non-limiting main body apparatus, a non-limiting left controller and a non-limiting right controller;

FIG. 8 is a view showing an example of a terrain object, which is a voxel object;

FIG. 9 is a view showing before and after the deletion of a portion of the terrain object shown in FIG. 8;

FIG. 10 is a view showing before and after the deletion of a portion of the terrain object shown in FIG. 8;

FIG. 11 is a diagram showing an example of content of voxel data and content of material information;

FIG. 12 is a diagram showing an example of property information representing properties of materials;

FIG. 13 is a diagram showing an example of texture information representing textures of materials;

FIG. 14 is a diagram showing a method for generating a mesh;

FIG. 15 is a view showing an example of a game image including a terrain object;

FIG. 16 is a view showing an example of a game image representing the player character punching the terrain object;

FIG. 17 is a view showing an example of a game image representing a portion of the terrain object removed by a punch of the player character;

FIG. 18 is a view showing an example of a game image representing the removed portion of the terrain object gradually restoring;

FIG. 19 is a view showing an example of the movement of a restoration region during the restoration process;

FIG. 20 is a view showing an example of a game image including the terrain object where change events occur;

FIG. 21 is a view showing an example of a game image showing the player character moving on a platform object;

FIG. 22 is a view showing an example of a primary voxel object and a sub-voxel object;

FIG. 23 is a view showing how a restorable object restores while moving;

FIG. 24 is a view showing a portion of a restorable object being separated;

FIG. 25 is a diagram showing an example of various data used in information processes performed in a non-limiting game system;

FIG. 26 is a flow chart showing an example of a flow of a game process executed by a non-limiting game system; and

FIG. 27 is a sub-flow chart showing an example of a detailed flow of a restoration process of step S9 shown in FIG. 26.

### DETAILED DESCRIPTION OF NON-LIMITING EXAMPLE EMBODIMENTS

### [1. Configuration of Game System]

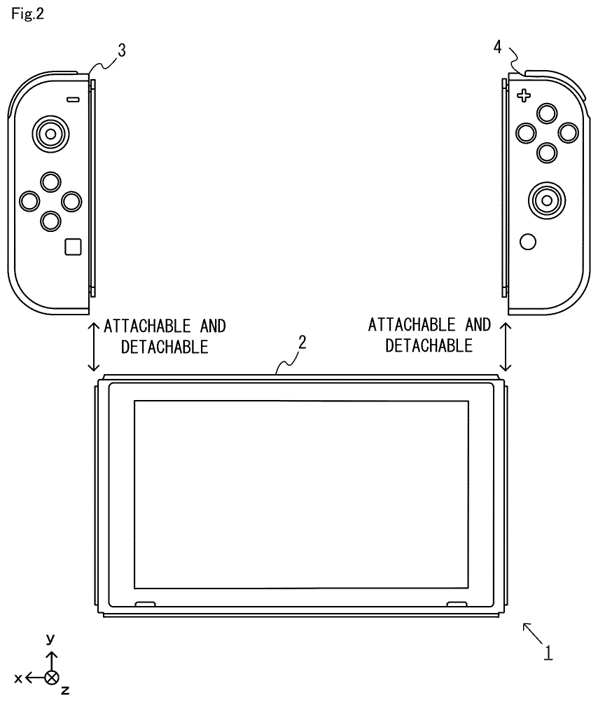

A game system according to an example of an exemplary embodiment is described below. An example of a game system 1 according to the exemplary embodiment includes a main body apparatus (an information processing apparatus; which functions as a game apparatus main body in the exemplary embodiment) 2, a left controller 3, and a right controller 4. Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2. Further, in the game system 1, the main body apparatus 2, the left controller 3, and the right controller 4 can also be used as separate bodies (see FIG. 2). Hereinafter, first, the hardware configuration of the game system 1 according to the exemplary embodiment is described, and then, the control of the game system 1 according to the exemplary embodiment is described.

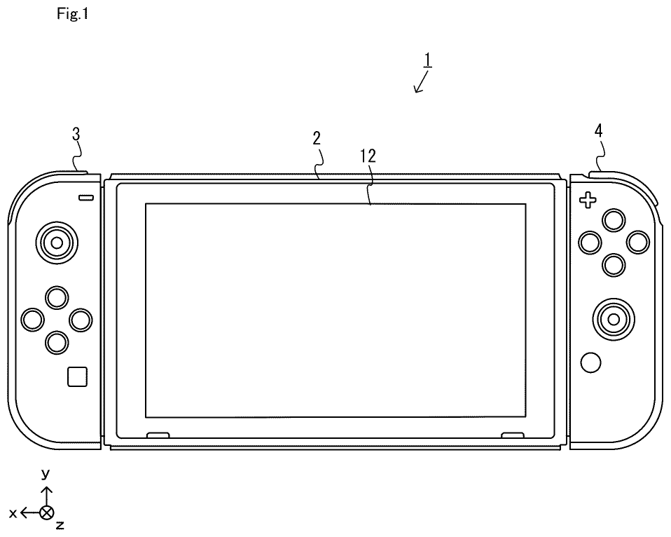

FIG. 1 is a diagram showing an example of the state where the left controller 3 and the right controller 4 are attached to the main body apparatus 2. As shown in FIG. 1, each of the left controller 3 and the right controller 4 is attached to and unified with the main body apparatus 2. The main body apparatus 2 is an apparatus for performing various processes (e.g., game processing) in the game system 1. The main body apparatus 2 includes a display 12. Each of the left controller 3 and the right controller 4 is an apparatus including operation sections with which a user provides inputs.

FIG. 2 is a diagram showing an example of the state where each of the left controller 3 and the right controller 4 is detached from the main body apparatus 2. As shown in FIGS. 1 and 2, the left controller 3 and the right controller 4 are attachable to and detachable from the main body apparatus 2. It should be noted that hereinafter, the left controller 3 and the right controller 4 will occasionally be referred to collectively as a “controller”.

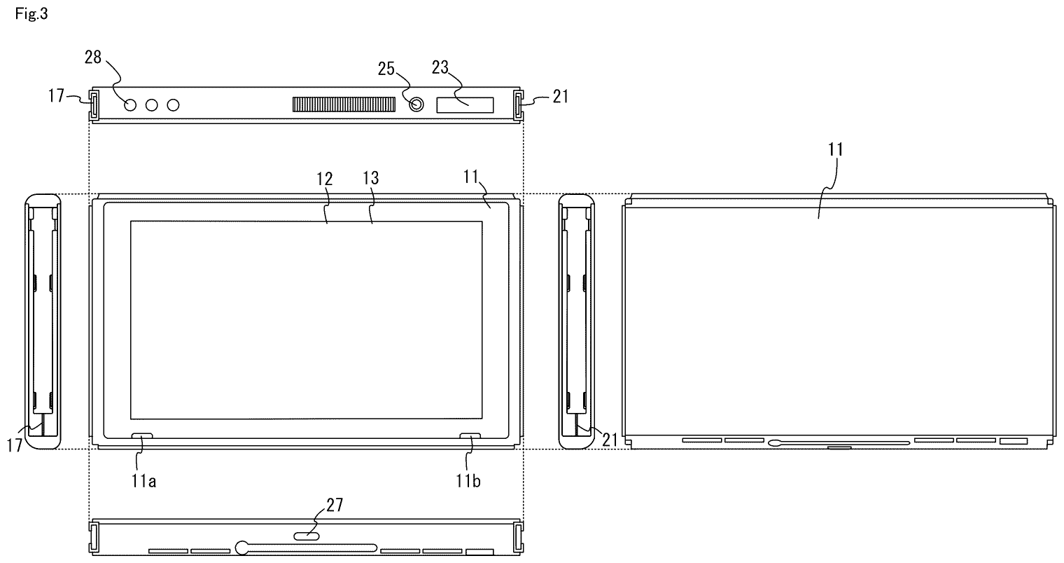

FIG. 3 is six orthogonal views showing an example of the main body apparatus 2. As shown in FIG. 3, the main body apparatus 2 includes an approximately plate-shaped housing 11. In the exemplary embodiment, a main surface (for example, a surface on a front side, such as a surface on which the display 12 is provided) of the housing 11 has a generally rectangular shape.

It should be noted that the shape and the size of the housing 11 are optional. As an example, the housing 11 may be of a portable size. Further, the main body apparatus 2 alone or the unified apparatus obtained by attaching the left controller 3 and the right controller 4 to the main body apparatus 2 may function as a mobile apparatus. The main body apparatus 2 or the unified apparatus may function as a handheld apparatus or a portable apparatus.

As shown in FIG. 3, the main body apparatus 2 includes the display 12, which is provided on the main surface of the housing 11. The display 12 displays an image generated by the main body apparatus 2. In the exemplary embodiment, the display 12 is a liquid crystal display device (LCD). The display 12, however, may be a display device of any type.

Further, the main body apparatus 2 includes a touch panel 13 on a screen of the display 12. In the exemplary embodiment, the touch panel 13 is of a type that allows a multi-touch input (e.g., a capacitive type). The touch panel 13, however, may be of any type. For example, the touch panel 13 may be of a type that allows a single-touch input (e.g., a resistive type).

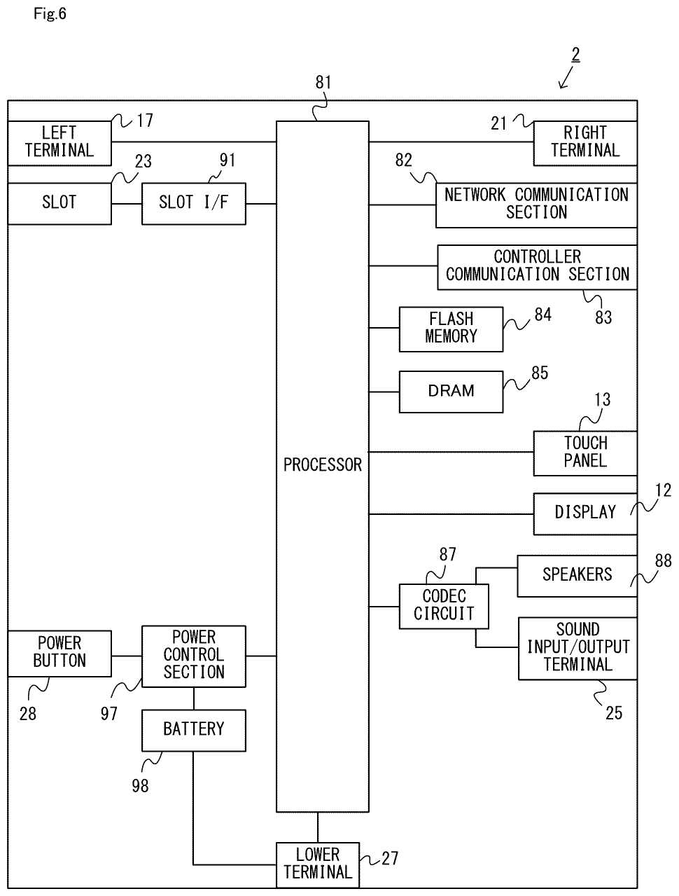

The main body apparatus 2 includes speakers (e.g., speakers 88 shown in FIG. 6) within the housing 11. As shown in FIG. 3, speaker holes 11a and 11b are formed on the main surface of the housing 11. Then, sounds output from the speakers 88 are output through the speaker holes 11a and 11b.

Further, the main body apparatus 2 includes a left terminal 17, which is a terminal for the main body apparatus 2 to perform wired communication with the left controller 3, and a right terminal 21, which is a terminal for the main body apparatus 2 to perform wired communication with the right controller 4.

As shown in FIG. 3, the main body apparatus 2 includes a slot 23. The slot 23 is provided on an upper side surface of the housing 11. The slot 23 is so shaped as to allow a predetermined type of storage medium to be attached to the slot 23. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of an application or the like) used by the main body apparatus 2 and/or a program (e.g., a program for an application or the like) executed by the main body apparatus 2. Further, the main body apparatus 2 includes a power button 28.

The main body apparatus 2 includes a lower terminal 27. The lower terminal 27 is a terminal for the main body apparatus 2 to communicate with a cradle. In the exemplary embodiment, the lower terminal 27 is a USB connector (more specifically, a female connector). Further, when the unified apparatus or the main body apparatus 2 alone is mounted on the cradle, the game system 1 can display on a monitor an image generated by and output from the main body apparatus 2. The monitor may be stationary or may be movable. Further, in the exemplary embodiment, the cradle has the function of charging the unified apparatus or the main body apparatus 2 alone mounted on the cradle. Further, the cradle has the function of a hub device (specifically, a USB hub).

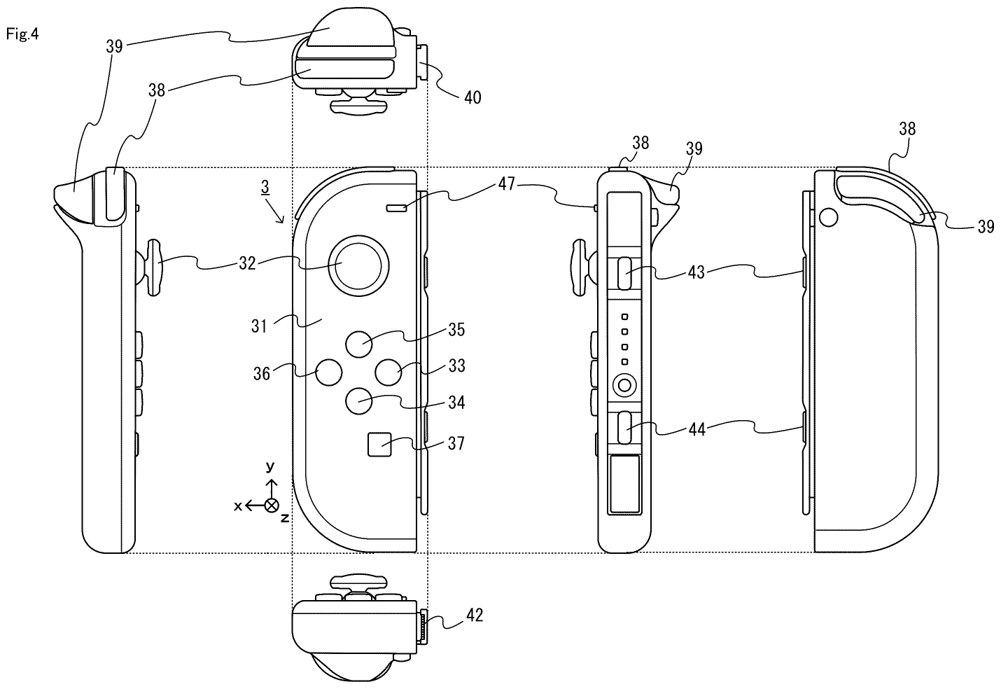

FIG. 4 is six orthogonal views showing an example of the left controller 3. As shown in FIG. 4, the left controller 3 includes a housing 31. In the exemplary embodiment, the housing 31 has a vertically long shape. The housing 31 may be shaped to be long in an up-down direction. For example, along the y-axis direction shown in FIGS. 1 and 4. In the state where the left controller 3 is detached from the main body apparatus 2, the left controller 3 can also be held in the orientation in which the left controller 3 is vertically long. The housing 31 has such a shape and a size that when held in the orientation in which the housing 31 is vertically long, the housing 31 can be held with one hand, particularly the left hand. Further, the left controller 3 can also be held in the orientation in which the left controller 3 is horizontally long. When held in the orientation in which the left controller 3 is horizontally long, the left controller 3 may be held with both hands.

The left controller 3 includes an analog stick 32. As shown in FIG. 4, the analog stick 32 is provided on a main surface of the housing 31. The analog stick 32 can be used as a direction input section with which a direction can be input. The user tilts the analog stick 32 and thereby can input a direction corresponding to the direction of the tilt (and input a magnitude corresponding to the angle of the tilt). It should be noted that the left controller 3 may include a directional pad, a slide stick that allows a slide input, or the like as the direction input section, instead of the analog stick. Further, in the exemplary embodiment, it is possible to provide an input by pressing the analog stick 32.

The left controller 3 includes various operation buttons. The left controller 3 includes four operation buttons 33 to 36 (specifically, a right direction button 33, a down direction button 34, an up direction button 35, and a left direction button 36) on the main surface of the housing 31. Further, the left controller 3 includes a record button 37 and a “−” (minus) button 47. The left controller 3 includes a first L-button 38 and a ZL-button 39 in an upper left portion of a side surface of the housing 31. Further, the left controller 3 includes a second L-button 43 and a second R-button 44, on the side surface of the housing 31 on which the left controller 3 is attached to the main body apparatus 2. These operation buttons are used to give instructions depending on various programs (e.g., an operating system (OS) program and an application program) executed by the main body apparatus 2.

Further, the left controller 3 includes a terminal 42 for the left controller 3 to perform wired communication with the main body apparatus 2.

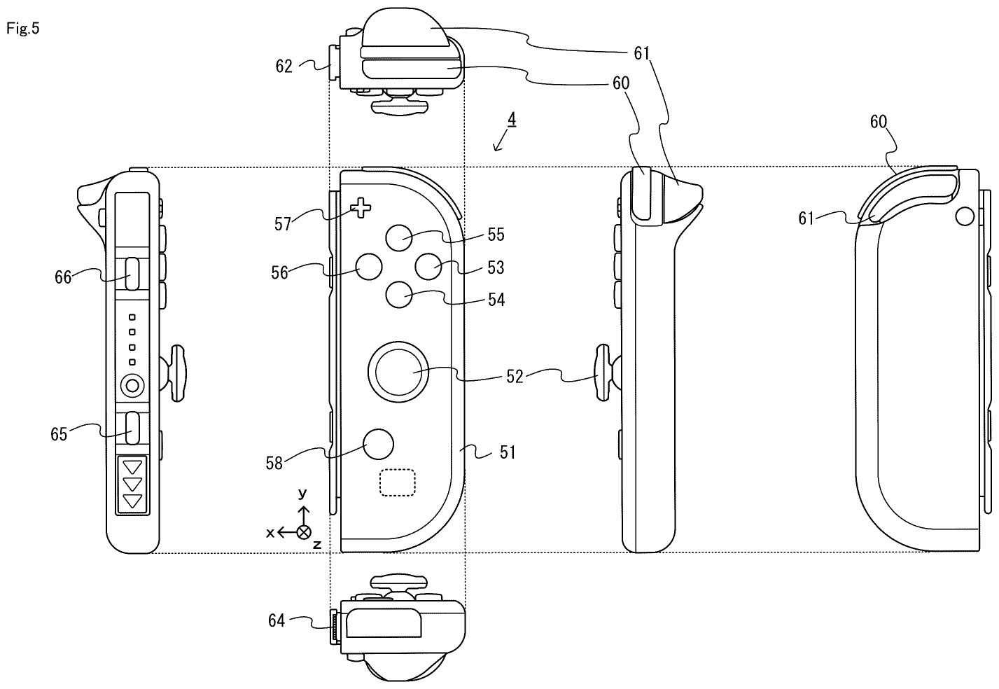

FIG. 5 is six orthogonal views showing an example of the right controller 4. As shown in FIG. 5, the right controller 4 includes a housing 51. In the exemplary embodiment, the housing 51 has a vertically long shape. For example, it may be shaped to be long in the up-down direction. In the state where the right controller 4 is detached from the main body apparatus 2, the right controller 4 can also be held in the orientation in which the right controller 4 is vertically long. The housing 51 has such a shape and a size that when held in the orientation in which the housing 51 is vertically long, the housing 51 can be held with one hand, particularly the right hand. Further, the right controller 4 can also be held in the orientation in which the right controller 4 is horizontally long. When held in the orientation in which the right controller 4 is horizontally long, the right controller 4 may be held with both hands.

Similarly to the left controller 3, the right controller 4 includes an analog stick 52 as a direction input section. In the exemplary embodiment, the analog stick 52 has the same configuration as that of the analog stick 32 of the left controller 3. Further, the right controller 4 may include a directional pad, a slide stick that allows a slide input, or the like, instead of the analog stick. Further, similarly to the left controller 3, the right controller 4 includes four operation buttons 53 to 56 (specifically, an A-button 53, a B-button 54, an X-button 55, and a Y-button 56) on a main surface of the housing 51. Further, the right controller 4 includes a “+” (plus) button 57 and a home button 58. Further, the right controller 4 includes a first R-button 60 and a ZR-button 61 in an upper right portion of a side surface of the housing 51. Further, similarly to the left controller 3, the right controller 4 includes a second L-button 65 and a second R-button 66.

Further, the right controller 4 includes a terminal 64 for the right controller 4 to perform wired communication with the main body apparatus 2.

FIG. 6 is a block diagram showing an example of the internal configuration of the main body apparatus 2. The main body apparatus 2 includes components 81 to 85, 87, 88, 91, 97, and 98 shown in FIG. 6 in addition to the components shown in FIG. 3. Some of the components 81 to 85, 87, 88, 91, 97, and 98 may be mounted as electronic components on an electronic circuit board and accommodated in the housing 11.

The main body apparatus 2 includes a processor 81. The processor 81 is an information processing section for executing various types of information processing to be executed by the main body apparatus 2. For example, the processor 81 may be composed only of a CPU (Central Processing Unit), or may be composed of a SoC (System-on-a-chip) having a plurality of functions such as a CPU function and a GPU (Graphics Processing Unit) function. The processor 81 executes an information processing program (e.g., a game program) or other instructions that are stored in storage. For example, in an internal non-transitory storage medium such as a flash memory 84, an external non-transitory storage medium attached to the slot 23, or the like), thereby performing the various types of information processing.

The main body apparatus 2 includes a flash memory 84 and a DRAM (Dynamic Random Access Memory) 85 as examples of internal storage media built into the main body apparatus 2. The flash memory 84 and the DRAM 85 are connected to the processor 81. The flash memory 84 is a memory mainly used to store various data (or programs) to be saved in the main body apparatus 2. The DRAM 85 is a memory used to temporarily store various data used for information processing. The DRAM 85 and flash memory 84 are illustrative non-limiting examples of non-transitory computer-readable media.

The main body apparatus 2 includes a slot interface (hereinafter abbreviated as “I/F”) 91. The slot I/F 91 is connected to the processor 81. The slot I/F 91 is connected to the slot 23, and in accordance with an instruction from the processor 81, reads and writes data from and to the predetermined type of storage medium (e.g., a dedicated memory card) attached to the slot 23.

The processor 81 appropriately reads and writes data from and to the flash memory 84, the DRAM 85, and each of the above storage media, thereby performing the above information processing.

The main body apparatus 2 includes a network communication section 82. The network communication section 82 is connected to the processor 81. The network communication section 82 communicates (specifically, through wireless communication) with an external apparatus via a network. In the exemplary embodiment, as a first communication form, the network communication section 82 connects to a wireless LAN and communicates with an external apparatus, using a method compliant with the Wi-Fi standard. Further, as a second communication form, the network communication section 82 wirelessly communicates with another main body apparatus 2 of the same type, using a predetermined communication method (e.g., communication based on a unique protocol or infrared light communication). It should be noted that the wireless communication in the above second communication form achieves the function of enabling so-called “local communication” in which the main body apparatus 2 can wirelessly communicate with another main body apparatus 2 placed in a closed local network area, and the plurality of main body apparatuses 2 directly communicate with each other to transmit and receive data.

The main body apparatus 2 includes a controller communication section 83. The controller communication section 83 is connected to the processor 81. The controller communication section 83 wirelessly communicates with the left controller 3 and/or the right controller 4. The communication method between the main body apparatus 2 and the left controller 3 and the right controller 4 is optional. In the exemplary embodiment, the controller communication section 83 performs communication compliant with the Bluetooth (registered trademark) standard with the left controller 3 and with the right controller 4.

The processor 81 is connected to the left terminal 17, the right terminal 21, and the lower terminal 27. When performing wired communication with the left controller 3, the processor 81 transmits data to the left controller 3 via the left terminal 17 and also receives operation data from the left controller 3 via the left terminal 17. Further, when performing wired communication with the right controller 4, the processor 81 transmits data to the right controller 4 via the right terminal 21 and also receives operation data from the right controller 4 via the right terminal 21. Further, when communicating with the cradle, the processor 81 transmits data to the cradle via the lower terminal 27. As described above, in the exemplary embodiment, the main body apparatus 2 can perform both wired communication and wireless communication with each of the left controller 3 and the right controller 4. Further, when the unified apparatus obtained by attaching the left controller 3 and the right controller 4 to the main body apparatus 2 or the main body apparatus 2 alone is attached to the cradle, the main body apparatus 2 can output data (e.g., image data or sound data) to the stationary monitor or the like via the cradle.

Here, the main body apparatus 2 can communicate with a plurality of left controllers 3 simultaneously (in other words, in parallel). Further, the main body apparatus 2 can communicate with a plurality of right controllers 4 simultaneously (in other words, in parallel). Thus, a plurality of users can simultaneously provide inputs to the main body apparatus 2, each using a set of the left controller 3 and the right controller 4. As an example, a first user can provide an input to the main body apparatus 2 using a first set of the left controller 3 and the right controller 4, and simultaneously, a second user can provide an input to the main body apparatus 2 using a second set of the left controller 3 and the right controller 4.

Further, the display 12 is connected to the processor 81. The processor 81 displays a generated image (e.g., an image generated by executing the above information processing) and/or an externally acquired image on the display 12.

The main body apparatus 2 includes a codec circuit 87 and speakers (specifically, a left speaker and a right speaker) 88. The codec circuit 87 is connected to the speakers 88 and a sound input/output terminal 25 and also connected to the processor 81. The codec circuit 87 is a circuit for controlling the input and output of sound data to and from the speakers 88 and the sound input/output terminal 25.

The main body apparatus 2 includes a power control section 97 and a battery 98. The power control section 97 is connected to the battery 98 and the processor 81. Further, although not shown in FIG. 6, the power control section 97 is connected to components of the main body apparatus 2 (specifically, components that receive power supplied from the battery 98, the left terminal 17, and the right terminal 21). Based on a command from the processor 81, the power control section 97 controls the supply of power from the battery 98 to the above components.

Further, the battery 98 is connected to the lower terminal 27. When an external charging device (e.g., the cradle) is connected to the lower terminal 27, and power is supplied to the main body apparatus 2 via the lower terminal 27, the battery 98 is charged with the supplied power.

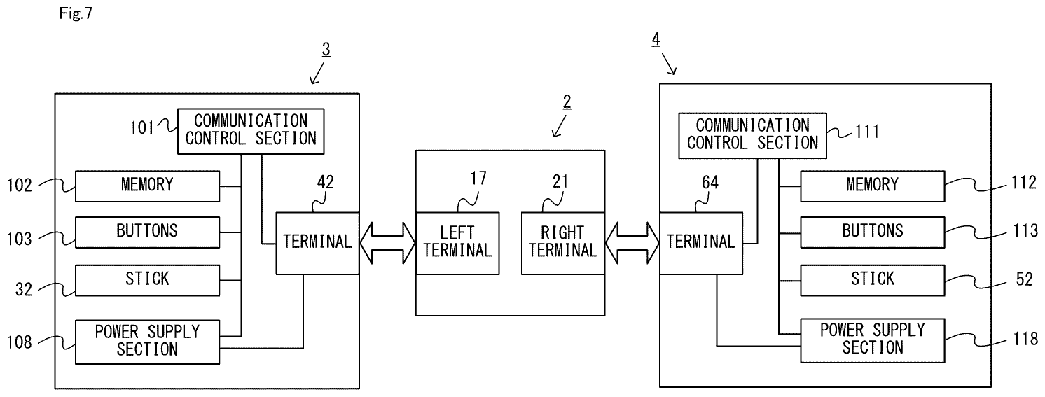

FIG. 7 is a block diagram showing examples of the internal configurations of the main body apparatus 2, the left controller 3, and the right controller 4. It should be noted that the details of the internal configuration of the main body apparatus 2 are shown in FIG. 6 and therefore are omitted in FIG. 7.

The left controller 3 includes a communication control section 101, which communicates with the main body apparatus 2. As shown in FIG. 7, the communication control section 101 is connected to components including the terminal 42. In the exemplary embodiment, the communication control section 101 can communicate with the main body apparatus 2 through both wired communication via the terminal 42 and wireless communication not via the terminal 42. The communication control section 101 controls the method for communication performed by the left controller 3 with the main body apparatus 2. That is, when the left controller 3 is attached to the main body apparatus 2, the communication control section 101 communicates with the main body apparatus 2 via the terminal 42. Further, when the left controller 3 is detached from the main body apparatus 2, the communication control section 101 wirelessly communicates with the main body apparatus 2 (specifically, the controller communication section 83). The wireless communication between the communication control section 101 and the controller communication section 83 is performed in accordance with the Bluetooth (registered trademark) standard, for example.

Further, the left controller 3 includes a memory 102 such as a flash memory. The communication control section 101 includes, for example, a microcomputer (or a microprocessor) and executes firmware stored in the memory 102, thereby performing various processes.

The left controller 3 includes buttons 103 (specifically, the buttons 33 to 39, 43, 44, and 47). Further, the left controller 3 includes the analog stick (“stick” in FIG. 7) 32. Each of the buttons 103 and the analog stick 32 outputs information regarding an operation performed on itself to the communication control section 101 repeatedly at appropriate timing.

The communication control section 101 acquires information regarding an input (specifically, information regarding an operation or the detection result of the sensor) from each of input sections (specifically, the buttons 103 and the analog stick 32). The communication control section 101 transmits operation data including the acquired information (or information obtained by performing predetermined processing on the acquired information) to the main body apparatus 2. It should be noted that the operation data is transmitted repeatedly, once every predetermined time. It should be noted that the interval at which the information regarding an input is transmitted from each of the input sections to the main body apparatus 2 may or may not be the same.

The above operation data is transmitted to the main body apparatus 2, whereby the main body apparatus 2 can obtain inputs provided to the left controller 3. That is, the main body apparatus 2 can determine operations on the buttons 103 and the analog stick 32 based on the operation data.

The left controller 3 includes a power supply section 108. In the exemplary embodiment, the power supply section 108 includes a battery and a power control circuit. Although not shown in FIG. 7, the power control circuit is connected to the battery and also connected to components of the left controller 3 (specifically, components that receive power supplied from the battery).

As shown in FIG. 7, the right controller 4 includes a communication control section 111, which communicates with the main body apparatus 2. Further, the right controller 4 includes a memory 112, which is connected to the communication control section 111. The communication control section 111 is connected to components including the terminal 64. The communication control section 111 and the memory 112 have functions similar to those of the communication control section 101 and the memory 102, respectively, of the left controller 3. Thus, the communication control section 111 can communicate with the main body apparatus 2 through both wired communication via the terminal 64 and wireless communication not via the terminal 64 (specifically, communication compliant with the Bluetooth (registered trademark) standard). The communication control section 111 controls the method for communication performed by the right controller 4 with the main body apparatus 2.

The right controller 4 includes input sections similar to the input sections of the left controller 3. Specifically, the right controller 4 includes buttons 113 and the analog stick 52. These input sections have functions similar to those of the input sections of the left controller 3 and operate similarly to the input sections of the left controller 3.

The right controller 4 includes a power supply section 118. The power supply section 118 has a function similar to that of the power supply section 108 of the left controller 3 and operates similarly to the power supply section 108.

### [2. Outline of Process on Game System]

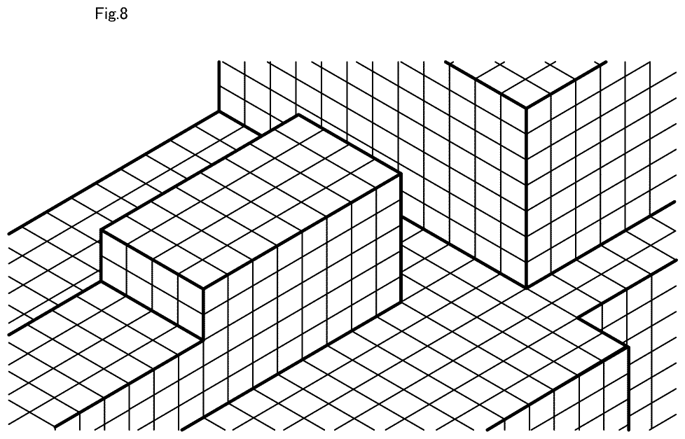

Next, referring to FIG. 8 to FIG. 24, an outline of the process performed on the game system 1 will be described. In the exemplary embodiment, the game system 1 generates a game image in which terrain objects and characters (e.g., the player character controlled by the player) are arranged in a game space, which is a three-dimensional virtual space, and displays the game image on a display device. Note that in the exemplary embodiment, the display device on which the game image is displayed may be the display 12 described above, or may be a stationary monitor.

### [2-1. Voxel]

In the exemplary embodiment, for some objects in the game space, the shape is defined by voxel data. Here, voxels are rectangular parallelepiped (more specifically, cubic) regions arranged in a grid pattern in the game space, and voxel data is data that is set for each voxel. Hereinafter, an object whose shape is defined by voxel data will be referred to as a “voxel object”. In the exemplary embodiment, the game system 1 stores voxel data for each of a plurality of voxels that are set in the game space as data for generating voxel objects in the game space.

FIG. 8 is a view showing an example of a terrain object, which is a voxel object. As shown in FIG. 8, in the exemplary embodiment, a terrain object representing a terrain such as a ground surface has its shape defined by voxel data. The cubes shown in FIG. 8 represent a terrain object. Note that in FIG. 8, edges of the terrain object are indicated by thick lines. However, these thick lines are added for the purpose of making the drawings easier to understand, and there is no need for edges of the terrain object to be drawn thick.

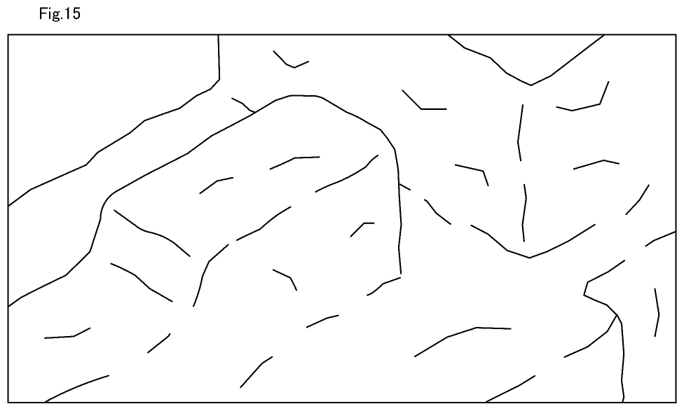

For example, the terrain object shown in FIG. 8 is generated by the following rule: “a cube is placed at the position of a voxel if a parameter included in the voxel data set for the voxel is greater than a predetermined value, and nothing is placed at the position of the voxel if the parameter is less than or equal to the predetermined value”. A terrain object in FIG. 8 is shown for the purpose of illustrating the relationship between voxels and voxel objects in an easy-to-understand manner. Note that in the exemplary embodiment, in practice, a voxel object is generated (e.g., based on voxel data) by such a rule that results in a terrain object having a complicated shape in comparison with the cubic voxels, such as a terrain object shown in FIG. 15 to be described below, for example. Note that there is no limitation on the rule for determining the shape of the voxel object based on the voxel data. In other embodiments, the game system 1 may generate a voxel object as shown in FIG. 8 based on the object data or may generate a voxel object as shown in FIG. 15 based on the object data.

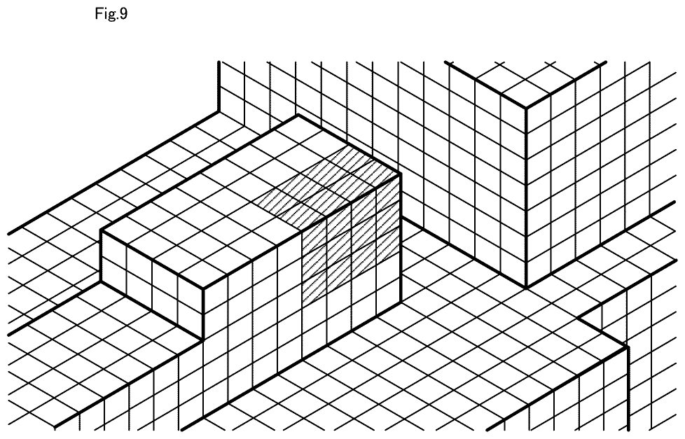

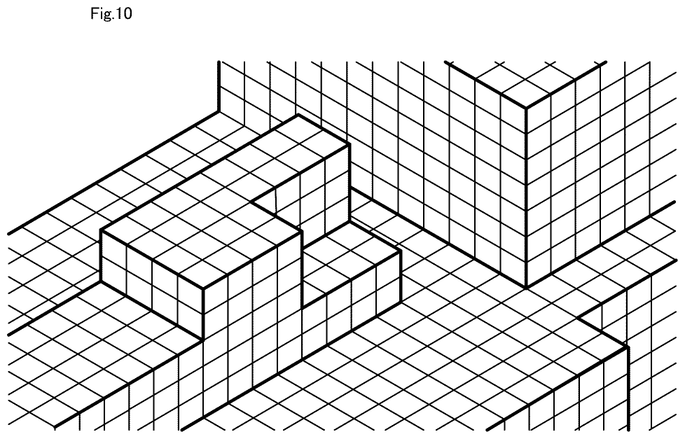

It is possible to change the shape of a voxel object by changing voxel data of voxels. FIG. 9 and FIG. 10 are views showing before and after the removal of a portion of the terrain object shown in FIG. 8. That is, when the hatched portion of the terrain object shown in FIG. 9 is broken, the terrain object changes to a shape as shown in FIG. 10. In such a case, the game system 1 can easily delete the terrain object by rewriting the voxel data described below so as to indicate that the terrain object is absent for voxels in the hatched portion. Note that also when making an addition to the terrain object, as when deleting the terrain object, the game system 1 can easily change the shape of the terrain object by changing the voxel data of voxels.

Thus, the game system 1 can freely change the shape of a voxel object by rewriting the voxel data. For example, the shape of a terrain object may be changed as a result of the terrain object in a game being broken for some reason (e.g., the player object striking the terrain object). In such a case, the game system 1 can freely change the shape of the terrain object by changing the voxel data used to generate the terrain object, rather than directly changing data representing the outer shape of the terrain object (e.g., the mesh to be described below).

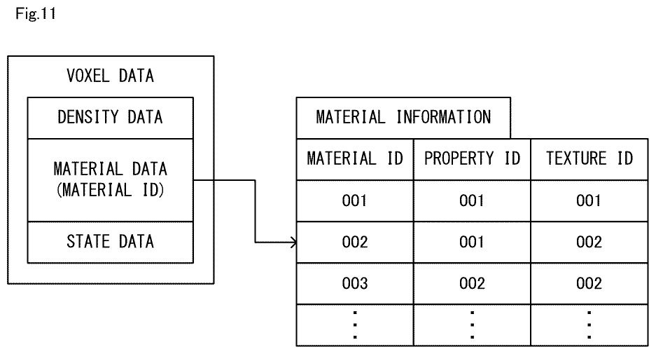

FIG. 11 is a diagram showing an example of content of voxel data. Here, in the exemplary embodiment, the game space can be divided into a plurality of voxels arranged in a grid pattern. The game system 1 stores voxel data for each voxel in the game space so that the voxel data is associated with the voxel. The voxel data represents, for example, the presence/absence of a voxel object in the voxel corresponding to the voxel data.

As shown in FIG. 11, voxel data includes density data. The density data represents the density, which is an index used to define the shape of a voxel object in the voxel corresponding to the voxel data (specifically, the shape defined by the mesh to be described below). As will be described in detail below, the position and the shape of the surface of the voxel object (e.g., the mesh to be described below) are determined based on this density. In other words, in the exemplary embodiment, this density is used to generate a mesh that defines the surface of the voxel object.

In the exemplary embodiment, the density can take an integer value in the range from the lower limit value (e.g., 0) to the upper limit value (e.g., 255). In the exemplary embodiment, the game system 1 determines the shape of a voxel object based on the density such that the proportion of the volume to be occupied by the voxel object in a voxel tends to be higher when the density value set for the voxel is higher and that the proportion tends to be lower when the density value is lower. Thus, the density is an index that affects the proportion of the volume to be occupied by the voxel object in the voxel. The density can also be said to be an index that represents the degree to which an object is included in the region defined by each voxel. For example, if the density is 0, there is no voxel object in the voxel, if the density is 255, the inside of the voxel is entirely the voxel object, and if the density is between 0 and 255, the inside of the voxel is occupied by the voxel object to the proportion that is determined based on the density value. Then, the shape of the mesh, e.g., the shape of the voxel object, can determined based on the density. Note however that the voxel object generated based on the density does not need to have a volume that exactly matches the proportion represented by the density. For example, the method of generating a voxel object as shown in FIG. 8 and the method of generating a voxel object as shown in FIG. 15 may differ in the volume of the voxel object, even if they are based on the same density.

In other embodiments, the density may indicate either a state in which the voxel object occupies the entirety of the region within the voxel or a state in which no voxel object is included in the region within the voxel. For example, the density data may be data that can take only 0 or 1.

As shown in FIG. 11, voxel data includes material data. The material data represents the material (in other words, the substance) of the voxel object generated by the voxel data. Here, in the exemplary embodiment, materials such as sand, rock and soil, for example, are set for voxel objects. That is, in the exemplary embodiment, a plurality of types of materials are provided as materials that can be set for a voxel object, and one of the materials is set for a voxel object.

As shown in FIG. 11, in the exemplary embodiment, the material data represents the identification information of the material (referred to as “material ID”). In the exemplary embodiment, the game system 1 stores material information representing the property and the texture of the material for each material provided in the game. In the exemplary embodiment, the material information represents associations between the material ID, the property of the material and the appearance (specifically, the texture) of the material. Specifically, the material information is information that represents associations between the material ID, identification information of the property of the material (referred to as “property ID”) and identification information of the texture of the material (referred to as “texture ID”) (see FIG. 11).

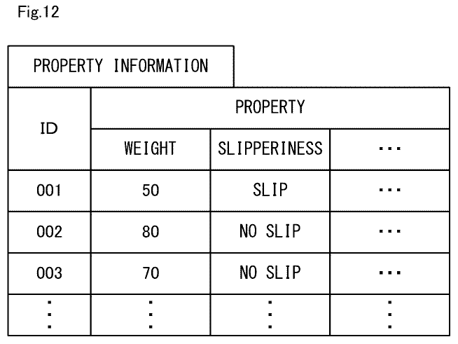

FIG. 12 is a diagram showing an example of property information representing properties of materials. As shown in FIG. 12, the game system 1 stores property information that associates each property ID with information that represents the content of the property represented by the property ID. A property of a material is a property of a voxel object for which the material is set in the game, and it may be information such as weight or slipperiness shown in FIG. 12, for example. Note that there is no limitation on the specific content of property. For example, the following information may be set as properties of a material.
Temperature
Breakability (e.g., the number of times of impact impartation needed to break a voxel object)
Whether another object can be bonded to a voxel object
Amount of hit points to be regained by the player character when the player character breaks a voxel object
Amount of in-game currency to be gained by the player character when the player character breaks a voxel object

Note that there is no limitation on the specific content of the property to be set for a material. In other embodiments, information different from those listed above may be set as information that represents a property of a material.

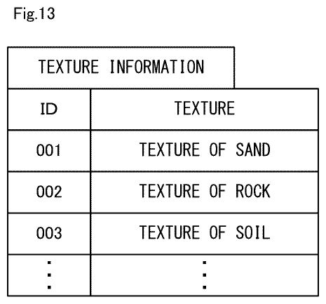

FIG. 13 is a diagram showing an example of texture information representing textures of materials. As shown in FIG. 13, the game system 1 stores texture information that associates the texture ID with the texture represented by the texture ID.

Note that in addition to information of texture, any information regarding the color and/or pattern may be set as data that defines the appearance of a voxel object. For example, a pattern of cracks may be set as information regarding the appearance of a voxel object. By using such a pattern, the game system 1 can generate an image of a voxel object that represents the appearance of cracks.

As described above, in the exemplary embodiment, the material data defines, by the material ID, the property of the voxel object and the texture used for the voxel object. For example, when the material ID represented by the material data included in the voxel data is “002”, the property represented by the property ID “001” that is associated with the material ID in the material information is set as the property of the voxel object corresponding to the voxel data (see arrow shown in FIG. 11). In this case, the texture that is represented by the texture ID “002” associated with the material ID in the material information is applied to the voxel object corresponding to the voxel data (see arrow shown in FIG. 11).

As described above, in the exemplary embodiment, the game system 1 separately manages the property and the texture of the material. Therefore, in the exemplary embodiment, it is possible to easily set a plurality of types of materials having the same property but having different appearances (e.g., different textures) or set a plurality of types of materials having different properties but having the same appearance.

Note that the material data may be any data with which it is possible to identify the property and/or the texture of the material. For example, in other embodiments, the material data may represent the property ID and the texture ID, or may have a data structure that actually includes data representing the property and the texture of the material.

The material data may further represent information related to the material other than the property and the texture described above. For example, the material data may include special effect data that represents the special effect to be triggered upon satisfaction of a special effect triggering condition set for the voxel object (e.g., a portion of the voxel object being broken, or the character stepping on the voxel object). Note that the special effect data may be data that represents a special effect image (e.g., a special effect image showing the voxel object being broken), or may be data that represents a special effect sound (a sound of footstep when the character walks on the voxel object).

As shown in FIG. 11, the voxel data includes state data that represents the state of the voxel object. There is no limitation on the specific content of the state data. For example, the state data may be data that represents whether the voxel object is in a wet state, or may be data that represents the amount of damage applied to the voxel object. The content of the state data may be updated during the game.

### [2-2. Mesh]

In the exemplary embodiment, the surface of the voxel object is represented by a mesh. A mesh is a set of faces (specifically, polygons) placed in the game space. In the exemplary embodiment, the game system 1 generates a mesh for the voxel object based on the voxel data of each voxel set in the game space. An example of how a mesh is generated based on voxel data will now be described.

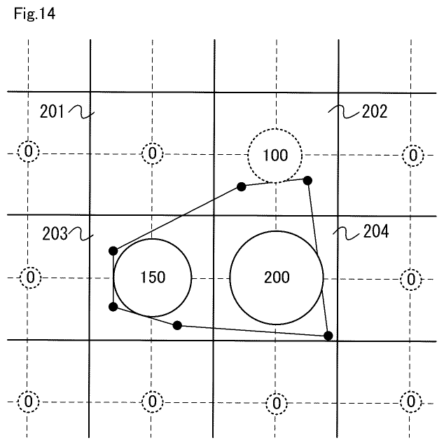

FIG. 14 is a diagram showing an example method for generating a mesh. Note that in FIG. 14, voxels and meshes are represented in two dimensions for the purpose of making the drawing easier to understand and for the sake of discussion, but in practice, a three-dimensional mesh is generated based on voxels in a three-dimensional space.

As described above, in the exemplary embodiment, the density set for the voxel is in the range of 0 to 255. In the exemplary embodiment, voxels with densities equal to or greater than the reference threshold value are considered to be inside the voxel object, and voxels with densities less than the reference threshold value are considered to be outside the voxel object. It is not necessary to define only voxels with a density of 0 as being outside the voxel object (e.g., reference threshold value=1), and the reference threshold value may be set to 128, for example. In the example shown in FIG. 14, a voxel 201 and the other outer voxels have a density of 0, a voxel 202 has a density of 100, which is less than the reference threshold value, and voxels 203 and 204 have densities of 150 and 200, which are greater than the reference threshold value. In the exemplary embodiment, the game system 1 generates vertices between those voxels whose densities are equal to or greater than the reference threshold value and those voxels whose densities are less than the reference threshold value. Specifically, for each region (region delimited by dotted lines) that straddles eight (four in the figure) adjacent voxels, it is determined whether or not to generate a vertex. That is, a vertex is generated in each region that straddles both a voxel whose density is equal to or greater than the reference threshold value and a voxel whose density is less than the reference threshold value. Then, a polygon mesh is generated by connecting together adjacent vertices if the connection (the boundary between the regions including the vertices) passes through a voxel whose density is equal to or greater than the reference threshold value and a voxel whose density is less than the reference threshold value. The coordinates of each vertex are determined by comparing densities of adjacent voxels and interpolating based on the difference in density for each of the XYZ axes. In this process, the coordinates can be further calculated based on the normal information. The normal information may be stored in advance for at least some of the voxels, or if not stored, the normal information may also be calculated based on densities between adjacent voxels. Note that in FIG. 14, the density of the voxel 202 is less than the reference threshold value, the voxel 202 is treated as being outside the voxel object in the determination of the presence/absence of a vertex, but the density value itself of the voxel 202 is used to calculate the coordinates of the vertices generated. If the reference threshold value were set to a value lower than the density of the voxel 202, it would result in an increase in the vertices on the upper right side and the upper left side in the voxel 202 of FIG. 14.

By generating a polygon mesh as described above, it is possible to generate a shape whose volume is based on (e.g., reflects) the density of each voxel to some extent. Note however that depending on the relationship with neighboring voxels, it is possible that a voxel with a density of 0 may partially include a region inside the voxel object, or a voxel with a density of 255 may partially include a region outside the voxel object. Since voxels with densities less than the reference threshold value are treated as being outside the voxel object in the exemplary embodiment, there are fewer vertices as compared with a case where those voxels are treated as being inside the voxel object, the volume will be smaller accordingly. That is, there is no need to calculate the polygon mesh so that the volume strictly corresponds to the density value.

FIG. 15 shows an example of a game image including a terrain object. In the exemplary embodiment, by generating a mesh as described above, the voxel object can be made in a shape with complicated irregularities compared to the cubic voxels, for example.

Note that there is no limitation on the method of generating a mesh based on voxel data. For example, in other embodiments, if the density of the voxel data is greater than a predetermined value, a mesh may be generated so that a cube is placed in the voxel (see FIG. 8).

For each face of the mesh generated as described above, the game system 1 determines the appearance (e.g., color and/or pattern) of each such face according to the material identified by the voxel data. Specifically, the game system 1 determines the texture to be used for rendering each face of the mesh based on the voxel data, and maps the determined texture to each face to generate an image of the voxel object. Note that the texture to be mapped to each face of the mesh is determined based on the voxel data of the voxel used to generate the face (which will be referred to as the target voxel) among the voxels where the voxel object exists. Note that the target voxel is, for example, one or more voxels located around the face, although it depends on the mesh generation method. That is, the texture mapped to a face of the mesh is determined to be a texture corresponding to the material set for one or more voxels placed around the face.

Note that in other embodiments, one voxel data may include multiple types (e.g., two types) of material data. In such a case, the voxel data includes ratio data related to the multiple types of material data. The ratio data is data for determining the texture to be used for the voxel object, and represents the ratio by which each of the materials (specifically, the texture corresponding to the material) represented by the multiple types of material data influences the appearance (specifically, the color and/or pattern) of the voxel object. When determining the texture to be mapped to each face of the mesh, the texture is determined based on various data (specifically, density data, multiple types of material data and ratio data) included in the voxel data of the target voxel. For example, when multiple types of materials are set for a target voxel corresponding to one face, a texture corresponding to the (one type of) material with the greatest degree of influence may be used while taking the ratio into consideration, or textures corresponding to multiple types of materials may be used while taking the ratio into consideration.

In other embodiments, there may be both voxel objects for which voxel data including one type of material data is used, and voxel objects for which voxel data including two types of material data is used.

### [2-3. Restoration of Voxel Object]

Next, the process of restoring a voxel object will be described. In the present embodiment, a predetermined object among the voxel objects arranged in the game space is changed by the occurrence of a game event that changes voxel objects (hereinafter referred to as a “change event”), and is thereafter restored to its original state in response to the satisfaction of the restoration condition. Hereafter, an object that is restored to the original state when changed will be referred to as a “restorable object”. The details of the restoration process for a restorable object will be described below.

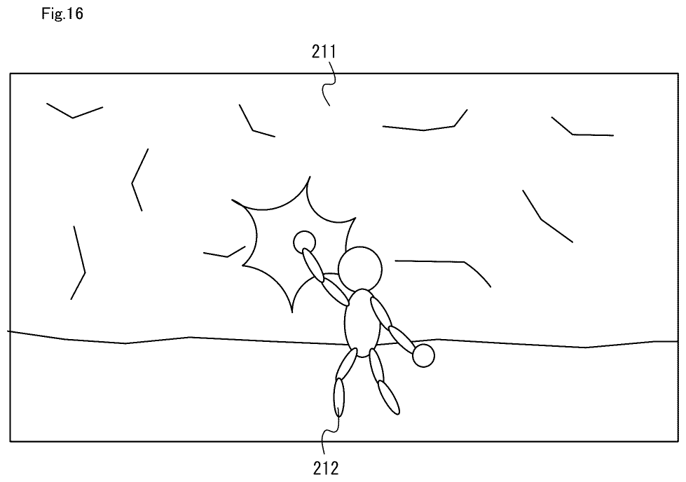

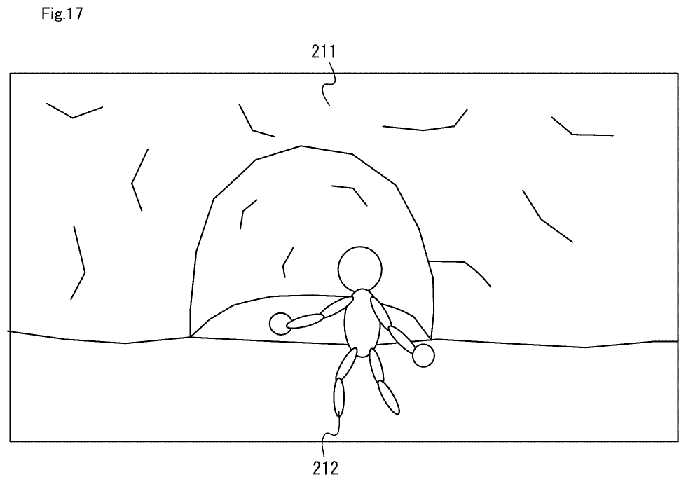

FIG. 16 is a view showing an example of a game image representing the player character punching the terrain object. FIG. 17 is a view showing an example of a game image representing a portion of the terrain object removed by a punch of the player character. Note that in the example illustrated herein, a terrain object 211, which represents a rock wall, is a voxel object and is a restorable object as described above. Note that not all the terrain objects in the game space need to be restorable objects that can be restored, and only some of the terrain objects may be restorable objects. Objects that are different from terrain objects may be restorable objects.

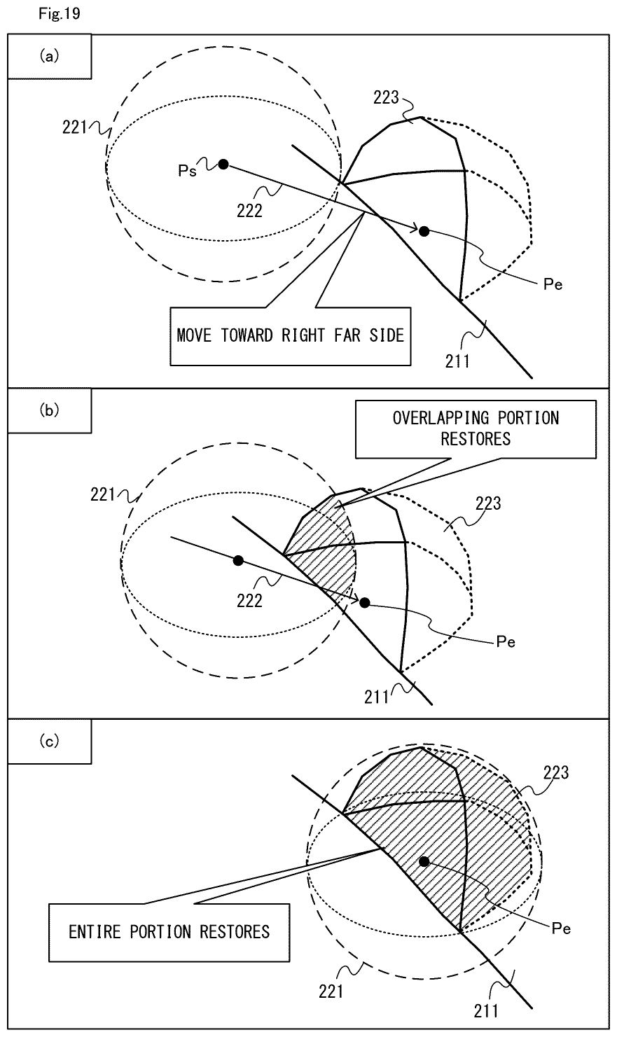

In the present embodiment, a player character 212 can perform a punch action in response to an operation by the player. The player character 212 can also remove (which can also be said to break) the terrain object 211 as shown in FIG. 17 by hitting the terrain object 211 with a punch. In the example shown in FIG. 17, the portion of the terrain object 211 where the punch of the player character 212 hit and the vicinity thereof (e.g., the changed portion 223 shown in FIG. 19) are removed.

As described above, in the present embodiment, the game system 1 changes a voxel object (specifically changes the shape of the voxel object) in response to the occurrence of a change event for the voxel object (e.g., being hit by a punch of the player character 212). Note that the change event is not limited to a voxel object being hit by a punch of the player character 212, but it may be any game event. For example, the change event may be the voxel object being hit by another object, or an explosion occurring near the voxel object. The range that is changed by a change event (e.g., a portion of the voxel object that is changed) may be determined in any way, for example, may be determined depending on the location at which the change event has occurred and/or the content of the change event.

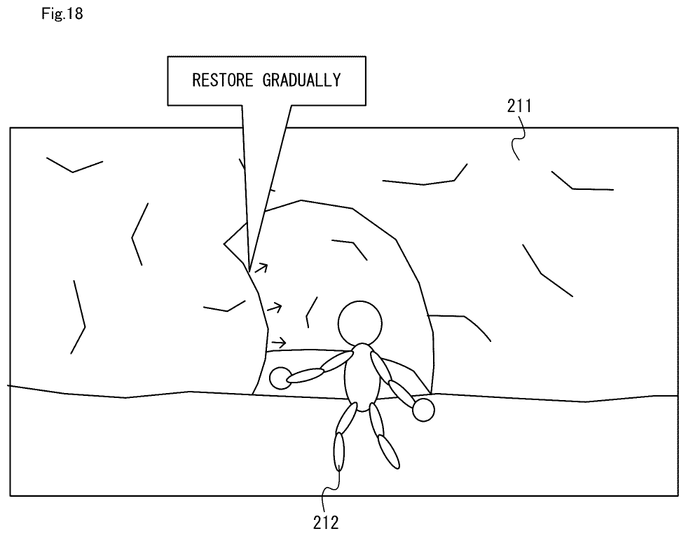

FIG. 18 is a view showing an example of a game image representing the removed portion of the terrain object gradually restoring. As shown in FIG. 18, in the present embodiment, when the terrain object 211 is removed, the game system 1 gradually restores the terrain object 211 in response to the satisfaction of the restoration condition. Specifically, the game system 1 gradually restores the removed portion of the terrain object 211 so as to gradually fill the space created by the removal of the terrain object 211 (see arrow shown in FIG. 18). In this way, the game system 1 can express how the terrain object 211 is gradually restored to the original shape.

Note that in the present embodiment, the restoration condition is that a predetermined amount of time (e.g., 2 seconds) has elapsed since the removal of the terrain object 211 in response to the change event. That is, the game system 1 executes the restoration process at a second timing subsequent to a first timing, which is determined based on the first timing at which the change event has occurred. According to this, the restorable object can be restored automatically (e.g., with or without an instruction from the player) after the occurrence of the change event.

Note that in the present embodiment, the second timing is a point in time at which a predetermined amount of time has elapsed since the occurrence of the change event, but is not limited to this. For example, in the other embodiments, when a series of change events occur (e.g., when a plurality of punches are thrown in a continuous series of actions), the second timing may be a point in time when a predetermined amount of time has elapsed since the end of the series of change events.

Note that in other embodiments, the restoration condition is arbitrary and is not limited to the above. For example, the restoration condition may be that a restoration operation is performed by the player. That is, the game system 1 may start the restoration process in response to an operation by the player. According to this, the player can freely restore objects. Here, “to start the restoration process in response to an operation by the player” can include both (a) to start the restoration process in response to the player performing a predetermined operation on the controller, and (b) to start the restoration process in response to the player character performing an action that satisfies a particular game condition, which is a restoration condition, as a result of the player performing an operation on the player character. An example of the former is, for example, the player pressing a specific button on the controller. An example of the latter is, for example, the player character standing at a specific location in the game space or the player character using a predetermined item as a result of an operation by the player.

FIG. 19 is a view showing an example of the movement of a restoration region during the restoration process. FIG. 19 shows how the restoration region moves when the restoration process is executed for the terrain object 211 shown in FIG. 18. Now, referring to FIG. 19, a specific example of the restoration process of the present embodiment will be described.

As shown in FIG. 19, in the present embodiment, the game system 1 sets a restoration region 221 in the game space when executing the restoration process. The restoration region 221 is a region where the restorable object is restored in the restoration process. That is, in the restoration process, a portion of the changed restorable object that is within the restoration region 221 is restored to its original state. Note that in the present embodiment, the restoration region 221 is a spherical region. Note however that the shape of the restoration region is arbitrary, and in other embodiments, it may be another shape (e.g., a cylinder or a cube).

FIG. 19(a) shows the state at a point in time when the restoration process is started. At the start of the restoration process, the game system 1 sets the size and a path 222 of the restoration region 221. Since the restoration region 221 is spherical in the present embodiment, the size of the restoration region 221 is defined by the radius of the sphere. In the present embodiment, the size of the restoration region 221 is set to a size that can contain the entirety of the changed portion (specifically, the removed portion) 223 of the terrain object 211, which is the restorable object.

The path 222 is a path along which the restoration region 221 (specifically, the center of the restoration region 221) moves during the restoration process. In the present embodiment, the path 222 is defined by the start position Ps and the end position Pe. The start position Ps is the position of the restoration region 221 at the start of the restoration process, and the end position Pe is the position of the restoration region 221 at the end of the restoration process. Note that in the present embodiment, the path 222 is assumed to be a straight line. Therefore, the path 222 is defined only by the start position and the end position. Note however that in other embodiments, the path 222 does not need to be a straight line, but may be a curved line or a zigzag line. For example, where an object moving in a circular arc trajectory contacts the terrain object 211 and the contacted portion of the terrain object 211 is removed as a result, the path may be set along this circular arc trajectory. Where the path is a curved line or a zigzag line, the game system 1 sets information for defining the path of a curved line or a zigzag line in addition to the start position and the end position. Note that the information for defining the path is arbitrary and is not limited to the start position and the end position. For example, in other embodiments, the path may be defined by the start position, the direction of movement and the distance of movement from the start position, or the path may be defined by the start position, the direction of movement, the speed of movement and the duration of movement from the start position.

At the start of the restoration process, the game system 1 arranges the restoration region 221 of the determined size at the start position Ps (see (a) in FIG. 19). Note that in the present embodiment, the position of the restoration region 221 is the position of the center of the spherical restoration region 221. In the present embodiment, the starting position Ps is set to a position such that the restoration region 221 is arranged in the vicinity of the changed portion (specifically, the removed portion) 223 of the terrain object 211, which is the restorable object and that the restoration region 221 does not overlap with the changed portion 223 (FIG. (see (a) in FIG. 19). Note that, as will be described in detail below, the end position Pe is set to a position such that the restoration region 221 arranged at the end position Pe includes the entirety of the changed portion 223.

During the restoration process, the game system 1 moves the restoration region 221 from the start position Ps to the end position Pe along the path 222. FIG. 19(b) shows a state in which the restoration region 221 has advanced halfway along the path 222. In this state, the game system 1 restores the object for a portion of the changed portion 223 that overlaps with the restoration region 221 (the hatched region shown in FIG. 19(b)). Thus, a portion of the changed portion 223 of the terrain object 211 is restored to its shape before the change.

In the present embodiment, the determination of the overlap between the changed portion 223 and the restoration region 221 is made based on voxels. That is, the game system 1 restores an object for voxels of the changed portion 223 that overlap with the restoration region 221. In the present embodiment, the game system 1 stores, for each voxel, the voxel data value before the change for the restorable object as the restoration reference value. The game system 1 updates the voxel data of each target voxel that is to be restored back to the restoration reference value. Thus, in the present embodiment, the object restoration is performed by the unit of voxels.

As described above, in the present embodiment, when a portion of the restorable object (here, the terrain object 211) is removed in response to a change event, the density value in the voxel data of the restorable object is updated. Therefore, the game system 1 stores the density value as the restoration reference value, and in the restoration process, sets the density value in the voxel data of the voxel to be restored back to the restoration reference value.

Note that the restoration reference value is, for example, the value when the restorable object is in its initial state (e.g., the state at the start of the game), but it is not limited to this. For example, where a restorable object gradually deforms from the shape at a point in time when the restorable object is first arranged and becomes a predetermined shape, the restoration reference value may be the value at the time the shape becomes the predetermined shape.

In the present embodiment, the game system 1 gradually restores the restorable object by restoring the object while moving the restoration region 221 along the path 222 during the restoration process. Note that, in the present embodiment, since the game system 1 restores objects by the unit of voxels, target voxels to be restored are successively designated along the path 222 as the restoration region 221 moves along the path 222. In the present embodiment, the game system 1 repeatedly executes the movement of the restoration region 221 and the restoration of objects based on the restoration region 221 after the movement for each frame time by which the game image is generated and displayed.

As described above, in the present embodiment, the game system 1 successively designates target voxels to be restored along the path set in the game space. Then, the game system 1 can gradually restore the portion of the restorable object that has been changed in the direction along the determined path.

In the present embodiment, the game system 1 also uses the restoration region to successively designate target voxels described above. That is, the game system 1 sets a restoration region in the game space and designates voxels, as target voxels, that overlap with the restoration region from among the plurality of voxels related to the restorable object, and successively designates target voxels by moving the restoration region along the path. Thus, by moving the restoration region, target voxels can be easily designated along the path.

Note that, in other embodiments, the game system 1 does not need to designate, as target voxels, all voxels overlapping with the restoration region from among the plurality of voxels related to the restorable object, but may select target voxels from among those of the plurality of voxels that overlap with the restoration region. For example, the game system 1 may designate, as target voxels, those voxels of which a predetermined percentage (e.g., 50%) or more of the voxel region overlaps with the restoration region. This also allows for easy designation of target voxels along the path, as in the present embodiment.

FIG. 19(c) shows a state in which the restoration region 221 has reached the end position Pe at the end of the restoration process. In the present embodiment, in the state where the restoration region 221 has reached the end position Pe, the restoration region 221 is arranged so as to cover the entirety of the changed portion 223 (the hatched region shown in FIG. 19(c)). Then, it is possible to ensure that the entirety of the changed portion 223 is restored at the end of the restoration process.

Note that, in other embodiments, the game system 1 does not need to arrange the restoration region 221 so as to cover the entirety of the changed portion 223 at the end of the restoration process. Then, by setting the path 222 and the size of the restoration region 221 so that the region through which the restoration region 221 passes during the restoration process covers the entirety of the changed portion 223, it is possible to ensure that the entirety of the changed portion 223 is restored.

In the present embodiment, the path 222 is set based on the content of the change event. For example, where the change event is an event caused by a punch action by the player character 212 as described above, the path 222 is set to be at a position corresponding to the punch contact position and to extend in a direction corresponding to the punch contact direction. Note that the punch contact position is the position at which the punch by the player object 212 contacts the restorable object (e.g., the terrain object 211). The punch contact direction is the direction of movement of the punch when the punch contacts the restorable object. For example, in the example shown in FIG. 16 to FIG. 19, since a portion of the restorable object over a predetermined range based on the punch contact position is removed, and the end position Pe is set so that the restoration region 221 includes the entirety of this portion, the path 222 can be said to be set based on the contact position.

The start position Ps of the path 222 is set so that the direction of the path 222 (e.g., the direction from the start position Ps to the end position Pe) is in accordance with the punch contact direction (e.g., a direction that coincides with the contact direction). For example, in the example shown in FIG. 16 to FIG. 19, the punch contact direction is from the front left to the far right as viewed from the player character 212, so the start position Ps is set so that the direction of the path 222 is from the front left to the far right. Then, the game system 1 can perform restoration along the direction corresponding to the content of the change event (specifically, the punch direction). For example, in the example described above, restoration is performed along the punch direction, so that even though the entirety of the changed portion 223 is actually removed at once by the punch, it is possible to give the player object 211 an impression as if the terrain object 211 was removed along the punch direction.

Note that in the example shown in FIG. 16 to FIG. 19, it is possible for the player character 212 to dig through the terrain object 211 to form a tunnel by repeatedly performing more punch actions before the terrain object 211 is restored. Then, the terrain object 211 is restored in the order of the previously removed portions (it can be said that the terrain object 211 is restored along the direction in which the player 212 dug the tunnel). Here, the game system 1 restores the terrain object 211 along the direction in accordance with the punch direction, and the terrain object 211 is restored in the direction from a position away from the player character 212 toward the player character 212, so that it is more unlikely that the player character 212 is buried in the terrain object 211. The terrain object 211 is restored along the direction of travel for the removed portion as a whole, and is restored along the direction in accordance with the punch direction for the unit of a single voxel (facing generally the same direction as the direction of travel). Thus, it is possible to express the terrain object 212 being restored continuously along the direction of travel of the player object 212.

As described above, in the present embodiment, the change event is the contact of a breaker object (in the above example, the player object 212) with a restorable object (in the above example, the terrain object 211) in the virtual space. When a change event occurs, the game system 1 updates the voxel data so that a portion of the restorable object that includes the position at which the broken object contacted is removed. The game system 1 sets the path 222 of the restoration region 221 so as to extend in the direction in accordance with the contact direction based on the position at which the breaker object contacted with the restorable object. Then, the restoration can be performed in a direction in accordance with the content of the change event (in the above example, the punch direction) at the position in accordance with the contact position.

Note that the game system 1 does not need to accurately detect the punch contact direction in order to set the direction of the path 222, but may set the direction of the path 222 based on the content of the change event so that the direction of the path 222 is in accordance with the punch contact direction. For example, if the change event is “the left hand punch of the player character 212 hitting the terrain object 211”, the game system 1 may set the direction of path 222 to be a direction from the front left to the far right with respect to the player character 212, and if the change event is “the right hand punch of the player character 212 hitting the terrain object 211”, the game system 1 may set the direction of the path 222 to be a direction from the front right to the far left with respect to the player character 212.

Note that, in other embodiments, the path of the restoration region may be set based on the restorable object. For example, the game system 1 may pre-set a path for each restorable object.

While the restoration region 221 is moved along the path 222 in the present embodiment, the game system 1 may change the size of the restoration region 221 instead of or in addition to moving the restoration region 221 along the path in other embodiments. For example, if the change event is that an explosion occurs near a restorable object (specifically, the terrain object 211) and if a portion of the restorable object that is in a predetermined range centered at the position of explosion is removed, the game system 1 may arrange the restoration region at the position of explosion and may gradually increase the size of the restoration region. Then, it is possible to express how the restorable object is restored successively starting from a position near the position of explosion to a position further away from the position of explosion.

As described above, in the present embodiment, the game system 1 successively designates target voxels to be restored from among the plurality of voxels related to the restorable object based on the designation rule, and restoration is performed for the designated voxels. This allows the restorable object to be restored successively according to a predetermined rule. Here, in the present embodiment, the designation rule is a rule that “voxels that overlap with the moving restoration region are target voxels”. Here, in other embodiments, the content of the designation rule is arbitrary. For example, in other embodiments, the designation rule may be to “designate target voxels successively in the direction from inside to outside of the restorable object (regardless of the content of the change event)”. Then, it is possible to express how a restorable object gradually restores from the inside. For example, the designation rule may be to “randomly select target voxels from among voxels of the changed portion”.

In the present embodiment, the game system 1 performs restoration by updating voxel data of target voxels so that the density becomes equal to the restoration reference value in one iteration. Here, in other embodiments, the game system 1 may update voxel data of target voxels so that the current (e.g., after the change) density value returns to the restoration reference value after a plurality of iterations. For example, the game system 1 may update voxel data of target voxels so that the density value comes closer to the restoration reference value with an upper limit value set for the amount of change for each iteration. Note that updating of voxel data may be repeated until the density becomes equal to the restoration reference value, even after the voxel of the voxel data moves out of the restoration region (in this case, it can also be said that the restoration region is expanded to include the restoration region before the movement and the restoration region after the movement).

Note that in the example shown in FIG. 16 to FIG. 19, a case in which a portion of the restorable object is removed by a change event has been described. That is, when a change event occurs for a restorable object, the game system 1 updates the voxel data so as to reduce the range of the game space occupied by the restorable object (e.g., so that at least a portion of the restorable object is removed). The restoration process is a process of increasing the area occupied by the restorable object in the game space. Here, the game system 1 may update voxel data so as to increase the area occupied by the restorable object in the game space (e.g., so that the volume of the restorable object is increased). Then, the restoration process decreases the area occupied by the restorable object in the game space.

Next, a restoration process where a plurality of change events occur successively will be described. In the present embodiment, there may be a situation in which after a change event occurs, another change event may occur before completion of the restoration process corresponding to the first change event. Note that “the restoration process corresponding to a change event” refers to the restoration process for restoring the portion of the restorable object that has been changed by the change event. In order to address such a situation, in the present embodiment, the game system 1 executes a plurality of restoration processes using a plurality of restoration region data. The details of the restoration process using restoration region data will be described below.

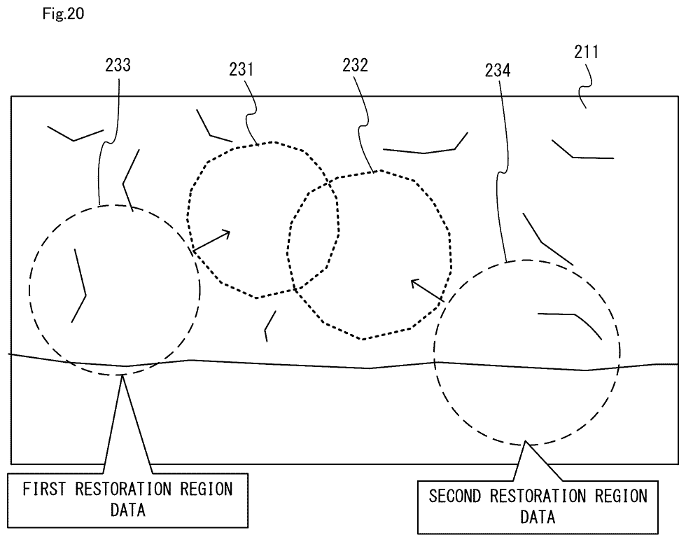

FIG. 20 shows an example of a game image including a terrain object in which a change event occurs. In the example shown in FIG. 20, a first changed portion 231 of the terrain object 211 is removed by the first change event, and a second changed portion 232 of the terrain object 211 is removed by the second change event.

In the present embodiment, the game system 1 executes the restoration process for each change event that occurs. Here, in the present embodiment, the game system 1 sets, for each restoration process, restoration region data for defining the restoration region to be used for the restoration process. In the example shown in FIG. 20, the first restoration region data used for the first restoration process corresponding to the first change event and the second restoration region data used for the second restoration process corresponding to the second change event are set. Note that the game system 1 manages the restoration region for each restoration process by setting a buffer for each restoration region data and storing the restoration region data in each buffer. In the example shown in FIG. 20, the first restoration region data for a first restoration region 233 used for the first restoration process and the second restoration region data for a second restoration region 234 used for the second restoration process are set.

In the present embodiment, the restoration region data includes data defining the path of the restoration region and the current state (specifically, the current position and size) of the restoration region. For example, the restoration region data may include data representing the position, the direction of movement and the size of the restoration region, and the amount of time elapsed since the start of the restoration process. In the present embodiment, the game system 1 can identify the path of the restoration region and the current state of the restoration region based on these data.

Note that the restoration region data may include any data with which it is possible to identify the path of the restoration region and the current state of the restoration region. For example, if the size of the restoration region changes during the restoration process, the restoration region data may include data with which it is possible to identify the size of the restoration region at each point in time during the restoration process.

In the present embodiment, when executing a plurality of restoration processes at a certain point in time, the game system 1 executes each restoration process independently based on the restoration region data set for the restoration process. Therefore, during the period when both of the first restoration process and the second restoration process are executed, the game system 1 performs restoration for voxels, as target voxels, that overlap at least one of the restoration region defined by the first restoration region data and the restoration region defined by the second restoration region data.

For example, where a first change event occurs and a second change event occurs thereafter for a portion of the terrain object 211 that corresponds to a certain voxel (specifically, the overlap portion between the first changed portion 231 and the second changed portion 232 in FIG. 20), consider the following two examples.

(Example 1) Where a second change event occurs in a range including this voxel before restoration is done for this voxel by the first restoration process corresponding to the first change event.

(Example 2) Where a second change event occurs in a range including this voxel after restoration is done for this voxel by the first restoration process corresponding to the first change event.

In Example 1, the game system 1 executes the first restoration process independently of the occurrence of the second change event. Therefore, this voxel is restored by the first restoration process after the occurrence of the second change event, without waiting for the second restoration process. That is, this voxel is restored at a point in time when a predetermined amount of time elapses from the occurrence of the first change event, regardless of whether or not the second change event has occurred.

On the other hand, in Example 2, in response to the second change event, the game system 1 again removes a portion of the voxel restored. Then, this voxel is restored again by the second restoration process corresponding to the second change event.

As described above, in the present embodiment, the game system 1 executes the restoration process corresponding to the change event independently, so that restoration can be done without waiting for the second restoration process in the case of Example 1, and it is possible to address the case where an object being restored is removed again in the case of Example 2. The game system 1 can reduce the risk of complicating the restoration process by executing different restoration processes independently, even when a plurality of restoration processes are executed in parallel due to a plurality of change events occurring successively.

As described above, in the present embodiment, when the first restoration condition is satisfied for a portion of the restorable object for which the first change event has occurred, the game system 1 successively designates target voxels based on the first restoration region data defining the path in the first restoration process corresponding to the first change event. When the second restoration condition is satisfied for a portion of the restorable object for which the second change event different from the first change event has occurred, the game system 1 successively designates target voxels based on the second restoration region data defining the path in the second restoration process corresponding to the second change event. Then, the game system 1 restores voxels, as target voxels, designated based on at least one of the first restoration region data and the second restoration region data, during an overlapping period between the period in which the first restoration process is executed and the period in which the second restoration process is executed. Then, it is possible to reduce the risk of complicating the restoration process even when a plurality of restoration processes are executed in parallel as a plurality of change events occur successively.

Although an example in which one restoration region data is set for one change event has been described above, a plurality of restoration region data may be set for one change event. That is, the game system 1 may execute a plurality of restoration processes using a plurality of restoration regions for one change event. For example, the game system 1 may set a plurality of restoration regions that move in different directions from each other for one change event, and execute the restoration process for each restoration region based on the restoration region data set for the restoration region. Also when a plurality of restoration region data are set as described above, the game system 1 executes the restoration process independently based on each restoration region data, as is the case when a plurality of restoration region data are set in response to a plurality of change events. Thus, it is possible to realize advantageous effects similar to those of the embodiment described above.

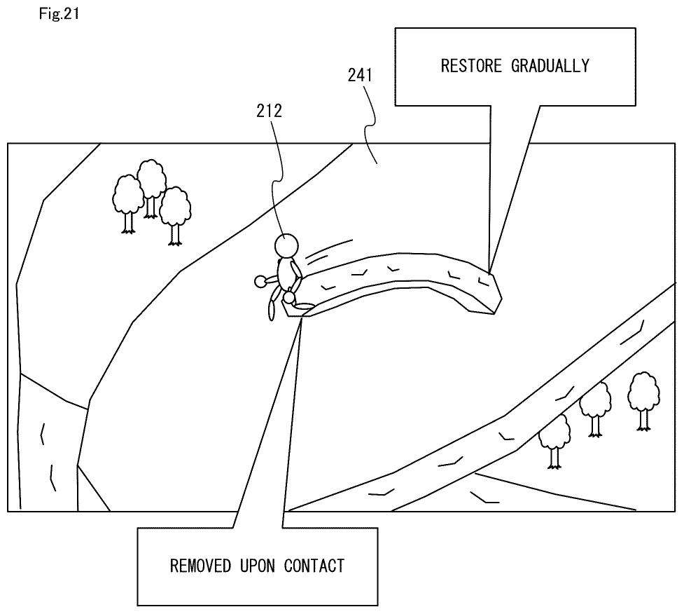

Next, referring to FIG. 21 to FIG. 24, another example of restoring a restorable object will be described. As shown in FIG. 21 to FIG. 24, the game system 1 can use the restoration process for the restorable object in various scenes in the game, not limited to a scene where a portion of the terrain object is removed by the punch action by the player character.

### Example where Ground Collapses

FIG. 21 is a view showing an example of a game image showing the player character moving on a platform object. In the example shown in FIG. 21, a platform object 241 is a type of a terrain object and is assumed to be a restorable object.

In the example shown in FIG. 21, a change event for the platform object 241 to be removed is the player character 212 being arranged on the platform object 241 (e.g., the player character 212 contacting the platform object 241). When the change event occurs, the game system 1 removes a portion of the platform object 241 that is within a predetermined range including the position at which the player character 212 made contact. Note that the platform object 241 has a predetermined thickness, and when a portion of the platform object 241 is removed by the change event, it is assumed that the portion is removed to the bottom. Therefore, when the platform object 241 is removed, the player character 212 cannot remain where the platform object 241 is removed but will fall down. Therefore, in order to keep the player character 212 from falling down from the platform object 241, the player performs a game operation so that the player character 212 keeps moving on the platform object 241. Note that in the present embodiment, the removal of the platform object 241 in response to the occurrence of a change event starts after a small amount of time has elapsed since the occurrence of the change event so that the player character 212 does not fall down upon contacting the platform object 241.

In the example shown in FIG. 21, the restoration condition for the platform object 241 is that a predetermined amount of time (e.g., 2 seconds) has elapsed since the removal of the platform object 241 in response to the change event, as in the example shown in FIG. 16 to FIG. 19. If the restoration condition is satisfied, the game system 1 restores the platform object by the restoration process described above.

Note that in the example shown in FIG. 21, the change event occurs each time the player character 212 contacts the platform object 241 while moving. Therefore, a restoration region is set for each time the player character 212 contacts the platform object 241 while moving, and the restoration process is executed for each restoration region. Note that in the example shown in FIG. 21, the amount of time from when the platform object 241 is removed until the removed portion is restored is constant regardless of the portion removed. Therefore, removed portions of the platform object 241 are successively restored starting from the portion that was removed first.

As described above, in the example shown in FIG. 21, the change event is that the player object (in the above example, the player character 212) is arranged on the restorable object in the game space. When the change event occurs, the game system 1 updates voxel data so as to remove a portion of the restorable object that includes the position at which the player object is arranged. Then, the game system 1 executes the restoration process at a second timing subsequent to a first timing at which the change event has occurred. Then, it is possible to realize a situation in the game where the player object will fall down unless the player object keeps moving on the restorable object (in the above example, the platform object 241), thereby improving the playability of the game. Since the restorable object is restored, it is possible to avoid the problem that the player object may run out of places to go as a result of continuing to move around.

### Example where Restorable Object Moves

The restorable object is not limited to a terrain object, but may be an object that moves and/or rotates in the game space. Then, a voxel object that is a restorable object may be a sub-voxel object as described below.

In the present embodiment, for other voxel objects that are different from the terrain object, the shape is defined by voxel data related to voxels that are different from the terrain object. Hereinafter, a voxel space related to the terrain object is called a “primary voxel space”, a voxel in the primary voxel space is called a “primary voxel”, and voxel data set for the primary voxel is called “primary voxel data”. On the other hand, a voxel space related to the other voxel objects is called a “sub-voxel space”, a voxel in the sub-voxel space is called a “sub-voxel”, and voxel data set for the sub-voxel is called “sub-voxel data”. In the present embodiment, the shape of the terrain object is defined by primary voxel data, and the shapes of the other voxel objects are defined by sub-voxel data. In the present embodiment, a voxel object whose shape is defined by primary voxel data is called a “primary voxel object”, and a voxel object whose shape is defined by sub-voxel data is called a “sub-voxel object”.

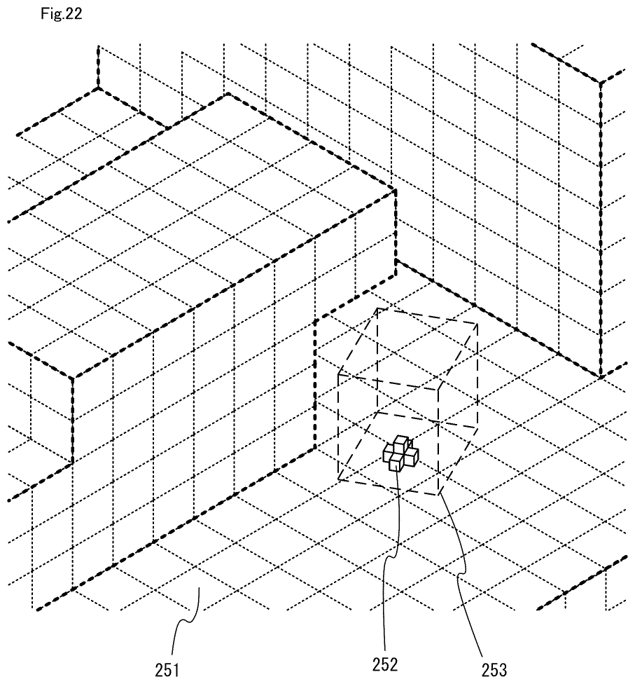

FIG. 22 is a view showing an example of a primary voxel object and a sub-voxel object. Note that for the purpose of showing the difference between a primary voxel and a sub-voxel in an easy-to-understand manner, FIG. 22 shows voxel objects (e.g., a terrain objects 251 and a rock object 252) for which a mesh is generated by the same rules as when generating a mesh for the terrain object shown in FIG. 8. That is, it is assumed that a mesh for the voxel object shown in FIG. 22 is generated by the rule that “if the density set for the voxel is greater than a predetermined value, a cube is arranged at the position of the voxel, and if the density is less than or equal to the predetermined value, nothing is arranged at the position of the voxel”. Note that in FIG. 22, for the purpose of making the drawing easier to read, the terrain object 251 is indicated by dotted lines, the rock object 252 is indicated by solid lines, and an area 253 of the sub-voxel space is indicated by broken lines.

For the terrain object 251, the shape is defined by primary voxel data. Note that in the present embodiment, the primary voxel space is assumed to be set in the entire game space (therefore, the range of the primary voxel space is not shown in FIG. 22).

On the other hand, for the rock object 252, the shape is defined by sub-object voxel data. Here, in the present embodiment, the sub-voxel space is set in a portion of the game space (which can be said to be a portion of the primary voxel space). Note that in the example shown in FIG. 22, the area 253 indicated by broken lines is the range where the sub-voxel space is set. The shape of the rock object 252 is defined by the sub-voxel data set for each sub-voxel set in the sub-voxel space. The rock object 252 will be arranged within the range of the sub-voxel space.

The length of one side of a sub-voxel may be set to be different from or the same as the length of one side of a primary voxel. Note that by setting a sub-voxel space that defines voxels with a side length shorter than that of primary voxels as sub-voxels, as shown in FIG. 22, for example, the shape of a sub-voxel object based on sub-voxel data can be expressed more finely than a terrain object based on primary voxel data.

In the present embodiment, the game system 1 sets directions of coordinate axes in the sub-voxel space (e.g., the direction of each side of a sub-voxel) independently of directions of coordinate axes in the primary voxel space (e.g., the direction of each side of a primary voxel). For example, in the example shown in FIG. 22, the directions of the coordinate axes in the sub-voxel space are different from the directions of the coordinate axes in the primary voxel space. This makes it easier to arrange sub-voxel objects in any direction in the game space. For example, it becomes easier to arrange a sub-voxel object so as to extend in a direction that is different from the coordinate axes in the primary voxel space. It is also easier to move (e.g., rotate) a sub-voxel object independently of the terrain object.

Note that the game system 1 can change the position of a sub-voxel object (more precisely, its position in the game space) by changing the position of the sub-voxel space in the game space. The game system 1 can also change the tilt of a sub-voxel object (more precisely, the tilt in the game space) by changing the tilt of the sub-voxel space with respect to the game space.

In the present embodiment, when a plurality of sub-voxel objects are generated, the game system 1 sets a sub-voxel space for each sub-voxel object. Then, it is possible to set the position and the tilt of each sub-voxel space in the game space for each sub-voxel space. It also makes it easier to generate a plurality of sub-voxel objects that have different shapes (e.g., a plurality of sub-voxel objects with shapes that extend in different directions from each other). Note that each sub-voxel space may be arranged so that a portion of the sub-voxel space overlaps with a portion of another sub-voxel space. In other embodiments, a plurality of sub-voxel objects may be set in one sub-voxel space.

Note that the method of generating the mesh of the sub-voxel object based on sub-voxel data may be the same as or different from the method of generating the mesh of the terrain object based on primary voxel data.

Where the sub-voxel object is a restorable object, the restorable object may move and/or rotate within the game space. For a restorable object that moves and/or rotates within the game space, the restoration process is executed as follows.

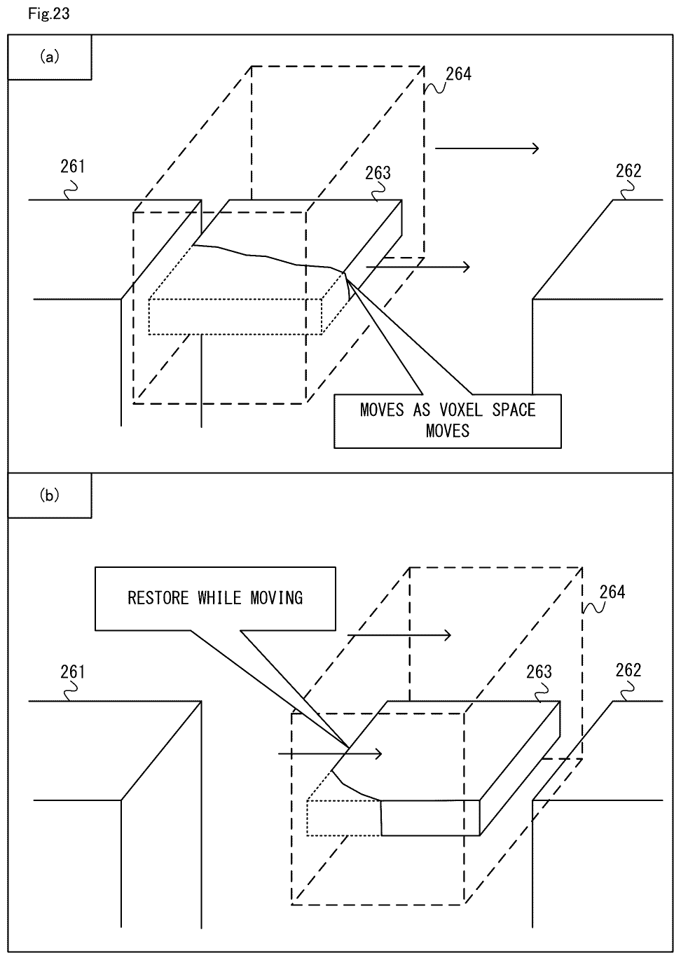

FIG. 23 is a view showing how a restorable object restores while moving. In the example shown in FIG. 23, a restorable object 263 is assumed to move between the terrain object 261 and the terrain object 262. FIG. 23(a) shows a state where a change event has removed a portion of the restorable object 263, and FIG. 23(b) shows a state where the restorable object 263 is being restored.

In FIG. 23, the game system 1 moves the restorable object 263 in the game space by moving the sub-voxel space 264 related to the restorable object 263 in the game space. Then, the positional relationship between the sub-voxel space and the restorable object 263 (which can also be said to be the position of the restorable object 263 with respect to the sub-voxel space) does not change.

If the restorable object 263 is removed as in FIG. 23(a), the game system 1 executes the restoration process for the restorable object 263 in response to the satisfaction of the restoration condition (e.g., a predetermined amount of time has elapsed since the removal). Note that in the example shown in FIG. 23, the restorable object 263 continues to move after being removed, so the position of the restorable object 263 is different at the time of removal and at the time of restoration. Here, in the present embodiment, the positional relationship between the sub-voxel space and the restorable object 263 has not changed because the restorable object 263 is moved by moving the sub-voxel space 264. That is, by moving the sub-object space 264, each voxel related to the restorable object 263 can be said to move so as to correspond to the position of the restorable object 263 having been moved, and the voxel data related to the restorable object 263 can be said to correspond to the position of the restorable object 263 having been moved. Therefore, in the restoration process, the game system 1 can perform restoration by updating the voxel data of voxels corresponding to the removed portion in the same way as when the restorable object 263 does not move.

As described above, in the present embodiment, the game system 1 moves, in the game space, the voxel space (in the example of FIG. 23, the sub-voxel space 264) in which voxels related to a restorable object are set, thereby moving the restorable object in the game space. Note that the game system 1 may rotate the voxel space and the restorable object in addition to (or instead of) moving the voxel space. If the restorable object is moved and/or rotated after the change event, the game system 1 executes the restoration process using voxel data related to the voxel space after the movement and/or rotation. Then, even if the restorable object is moved and/or rotated, the restorable object can be restored by the same process as when the object is not moved and/or rotated, thereby reducing the processing load of the game system 1.

### Example where Restorable Object is Separated

The restorable object may have a property such that a portion of the restorable object can be separated by a change event. Here, where a portion of one object is removed, separation of an object is meant to include the generation of an object that represents the removed portion. That is, when an object is separated, two objects will be arranged in the game space: the object and the separated object (hereinafter referred to as the “separated object”). Note that the separated object and the unseparated original object do not need to be treated as one object, but may be treated as separate objects. In the present embodiment, the separation may be performed for the restorable object. The restoration process to be performed in the case where a restorable object is separated will now be described.

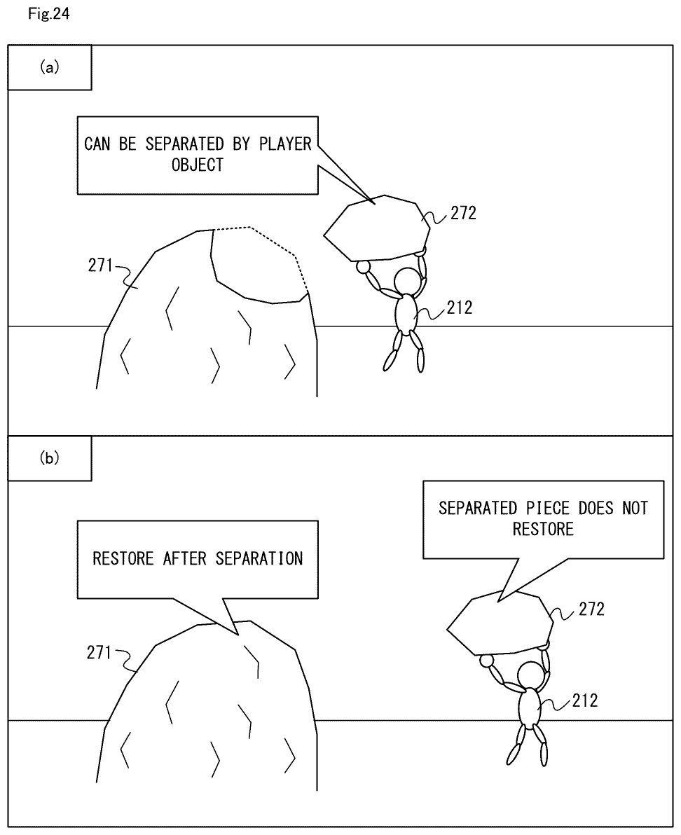

FIG. 24 is a view showing a portion of a restorable object being separated. In the example shown in FIG. 24, it is assumed that the player character 212 can perform a separation operation on a restorable object 271. That is, when the player character 212 performs a separation action on the restorable object 271, a portion of the restorable object 271 is removed, and a separated object 272 representing the removed portion is generated (see (a) in FIG. 24).

Note that in the example described above, the player character 212 is allowed to move while holding the separated object 272. For example, the restorable object 271 may have a particular property (e.g., an explosive property or a property of glowing and illuminating the surroundings), and the separated object 272 is then set to have the same property as the restorable object 271. Therefore, the player character 212 can obtain the separated object 272 from the restorable object 271, and can make use of the property of the restorable object 271, which cannot be moved, in a place away from the restorable object 271. For example, the player character 212 can obtain the separated object 272 from the restorable object 271, which has an explosive property, and hit an enemy object (not shown) with the obtained object, or obtain the separated object 272 from the restorable object 271, which has a property of illuminating the surroundings, and illuminate the inside of a cave. Note that the separated object 272 may be removed under certain conditions (e.g., in response to elapse of a predetermined amount of time).

In the example shown in FIG. 24, if a portion of the restorable object 271 is removed due to the separation of the restorable object 271, the game system 1 executes the restoration process for the restorable object 271 (see (b) in FIG. 24) in response to the satisfaction of the restoration condition (e.g., in response to the passage of a predetermined amount of time since the removal). This restoration process is executed in a similar manner to the restoration process in the example shown in FIG. 16 to FIG. 19. Note that the restorable object 271 may be a primary voxel object described above or may be a sub-voxel object.

For example, consider an example in which the use of the property possessed by the restorable object 271 is the condition for progressing the game. For example, an example of this is a case in which the restorable object 271 has an explosive property, and the game can be progressed by defeating enemy characters using the separated object 272. In the example described above, if the restorable object 271 cannot be restored, the player may become unable to progress the game if the restorable object 271 is eventually eliminated as a result of repeating the operation of obtaining the separated object 272 from the restorable object 271. In this regard, in the present embodiment, restoring the restorable object 271 reduces the possibility that such a problem occurs in the game.

On the other hand, the game system 1 does not execute the restoration process for the separated object 272 generated by the separation performed on the restorable object 271 (see (b) in FIG. 24). Thus, it is possible to avoid the problem that the separated object grows bigger while being held by the player character 212. It is possible to reduce the processing load of the game system 1 by not executing unnecessary restoration processes. Note that since the restoration process is not executed for the separated object as described above, the separated object may or may not be a voxel object.

As described above, in the present embodiment, when a change event occurs for a restorable object, a portion of the restorable object is removed, and a separated object corresponding to the reduced portion generated. Then, if the restoration condition is satisfied for the restorable object, the game system 1 executes the restoration process for the restorable object and does not execute the restoration process for the separated object. Then, it is possible to reduce the possibility of a problem in the game, and it is possible to reduce the processing load of the game system 1.

### 3. Specific Example of Process in Game System

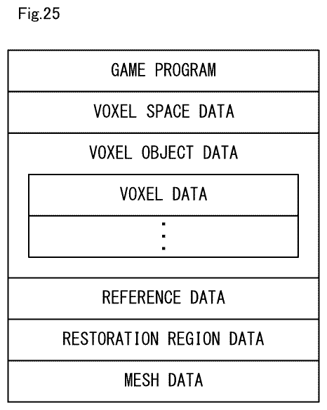

Next, with reference to FIG. 25 to FIG. 27, a specific example of the information process performed in the game system 1 will be described.

FIG. 25 is a diagram showing an example of various data used in information processes performed in the game system 1. As shown in FIG. 25, the game system 1 stores a game program, voxel space data, voxel object data, reference data, restoration region data and mesh data.

The game program, the voxel space data and the reference data are data that are stored in the game system 1 in advance before executing the game process. These data are stored, for example, in a storage medium attached to the slot 23 of the main body apparatus 2. Note that in addition to the data shown in FIG. 25, the game system 1 stores the property information and the texture information data described above, as well as data related to various characters appearing in the game, as data to be stored in the game system 1 in advance before executing the game process. The voxel object data, the restoration region data and the mesh data are data generated during the execution of the game process. These data are stored in the DRAM 85 of the main body apparatus 2, for example.

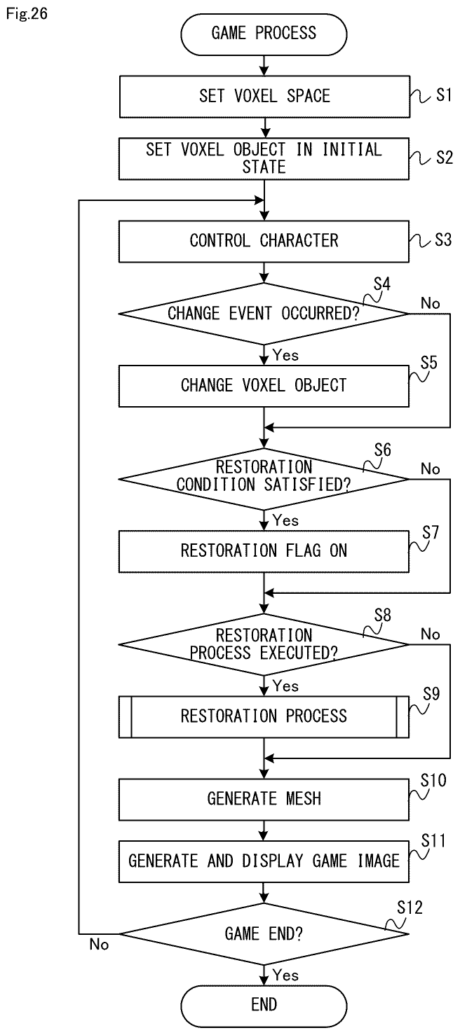

The game program is a game program for executing the game process in the present embodiment (specifically, the game process shown in FIG. 26).

The voxel space data is stored for each voxel space. Note that, when a voxel space is set for each voxel object (e.g., when a sub-voxel space is set for each sub-voxel object), voxel space data and restoration region data may be said to be stored for each voxel object (e.g., a primary voxel object or a sub-voxel object). The voxel object data, the reference data and the mesh data are stored for each voxel object.

Voxel space data is data that defines the voxel space set in the game space. Specifically, voxel space data represents the length of one side of a voxel and the direction of each side of a voxel in the game space. When a voxel space is set only in a portion of the game space (e.g., when the voxel space is a sub-voxel space), voxel space data may include data that represents the position and size of the voxel space (e.g., data representing the range in the game space where voxels are set).

Voxel object data is data that represents voxel objects (herein, restorable objects) arranged in the game space. Specifically, voxel object data includes voxel data for each voxel in the voxel space for the voxel object.

The reference data represents the restoration reference value described above. In the present embodiment, the reference data represents the restoration reference value for each of a plurality of voxels related to the restorable object. In the present embodiment, since the restoration reference value is set for each voxel, it is possible to easily restore the restorable object by the unit of voxels. Note that the reference data may include only the density data for each voxel, or it may include the same content as voxel data (e.g., it may include data other than the density).

The restoration region data represents various information related to the restoration region described above. In the present embodiment, the restoration region data includes data defining the path of the restoration region and the current state (specifically, the current position and size) of the restoration region.

Mesh data is data that represents a mesh (e.g., the mesh of the restorable object) that is set for a voxel object arranged in the game space. Mesh data includes, for example, data representing the position of each vertex of the mesh.

FIG. 26 is a flow chart showing an example of the flow of the game process to be executed by the game system 1. The game process shown in FIG. 26 is started in response to the player giving an instruction to start the game during execution of the game program, for example.

Note that in the present embodiment, it is assumed that the processor 81 of the main body apparatus 2 executes the game program stored in the game system 1, thereby executing the processes of the steps shown in FIG. 26. Note however that in other embodiments, some of the processes of the steps described above may be executed by another processor (e.g., a dedicated circuit, or the like) different from the processor 81. Where the game system 1 can communicate with another information processing apparatus (e.g., a server), some of the processes of the steps shown in FIG. 26 may be executed in the other information processing apparatus. The processes of the steps shown in FIG. 26 are merely illustrative, and the order of steps to be performed may be switched around or other processes may be executed in addition to (or instead of) the processes of the steps, as long as similar results are obtained.

The processor 81 executes the processes of the steps shown in FIG. 26 using a memory (e.g., the DRAM 85). That is, the processor 81 stores information (in other words, data) obtained in each process step in the memory, and when the information is used in a subsequent process step, the information is read out from the memory and used.

In step S1 shown in FIG. 26, the processor 81 sets a voxel space in the game space. Specifically, the processor 81 obtains the voxel space data, and stores (in other words, writes) the obtained data in the DRAM 85. Note that in subsequent game processes, the processor 81 may refer to the voxel space data when executing a process related to a voxel object (e.g., the process of step S2, etc.). In this case, the processor 81 refers to the voxel space data stored in the DRAM 85. The process of step S2 is executed, following step S1.

In step S2, the processor 81 sets voxel objects in the game space in the initial state. Specifically, the processor 81 obtains voxel data representing the arrangement of voxel objects in the initial state, and stores (in other words, writes) a part or whole of the obtained voxel data in the DRAM 85 as voxel object data. Note that voxel data representing the arrangement of voxel objects in the initial state is stored, for example, in a storage medium attached to the slot 23 of the main body apparatus 2. The process of step S3 is executed, following step S2.

Note that the voxel data written to the DRAM 85 as voxel object data may be voxel data of a partial range of the game space that is used for the generation of the game image, of the primary voxel data for the entire range of the game space. For example, the processor 81 may generate the image of a voxel object by using the voxel data only for a partial range of the game space (e.g., the range within a predetermined distance from the position of the virtual camera). In this case, the voxel object data may include voxel data within that range. Where the voxel data for a partial range of the game space is written, a similar process to step S2 described above is executed at an appropriate point in time during the execution of a series of processes of steps S3 to S12 to be described below (e.g., at a point in time when the position of the virtual camera has moved a predetermined distance or more).

In step S3, the processor 81 controls the action of various objects (e.g., the player character and a voxel object that moves as shown in FIG. 23) that appear in the game space. For example, the processor 81 controls the action of the player object based on operation data received from the controller 3 or 4, or controls the action of the voxel object based on an algorithm defined in the game program. The process of step S4 is executed, following step S3.

In step S4, the processor 81 determines whether a change event has occurred for a voxel object in response to the process of step S3. For example, the processor 81 determines whether a change event has occurred as a result of causing the player character or the voxel object to perform an action. If the determination result from step S4 is affirmative, the process of step S5 is executed. On the other hand, if the determination result from step S4 is negative, the process of step S6 is executed, skipping the process of step S5.

In step S5, the processor 81 changes the voxel object for which the change event has occurred, depending on the change event. In the present embodiment, the processor 81 changes the density represented by the voxel data for at least some of the voxels related to the voxel object for which the change event has occurred. This deforms the voxel object for which the change event has occurred. The processor 81 updates the voxel object data stored in the DRAM 85 so as to represent the changed density. The process of step S6 is executed, following step S5.

In step S6, the processor 81 determines whether the restoration condition is satisfied for the change event determined to have occurred in step S4. If the determination result from step S6 is affirmative, the process of step S7 is executed. On the other hand, if the determination result from step S6 is negative, the process of step S8 is executed, skipping the process of step S7.

In step S7, the processor 81 turns ON the restoration flag that is set for the change event for which the restoration condition is satisfied. Here, in the present embodiment, the game apparatus 2 stores, in the DRAM 85, flag data of the restoration flag, for each change event that has occurred, representing whether or not the restoration process corresponding to the change event has been executed. The restoration flag is set for each change event. The flag data indicates that the flag is OFF at the point in time when the change event occurs for the voxel object. In step S7, the processor 81 updates the flag data for the voxel object for which the restoration condition is satisfied to indicate ON. The process of step S8 is executed, following step S7.

In step S8, the processor 81 determines whether or not to execute the restoration process for the restorable object. Specifically, the processor 81 determines whether or not there exists a restoration flag that is set to ON. If the determination result from step S8 is affirmative, the process of step S9 is executed. On the other hand, if the determination result from step S8 is negative, the process of step S10 is executed, skipping the process of step S9.

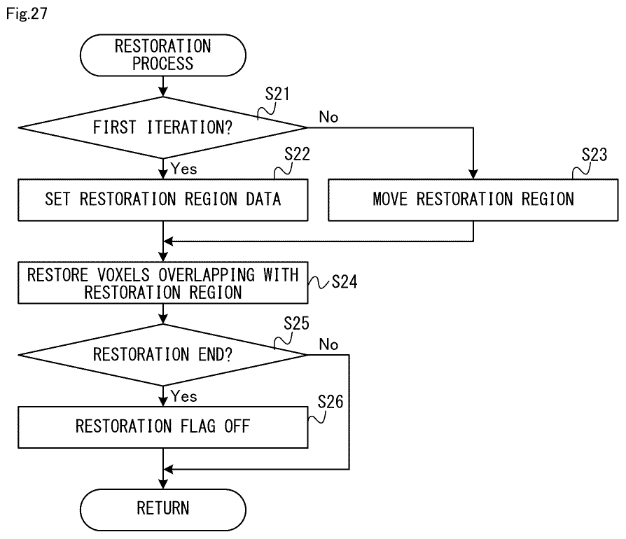

In step S9, the processor 81 executes the restoration process to restore the restorable object for which the restoration flag is set to ON (e.g., the restorable object corresponding to the change event for which the restoration flag is set to ON). The detailed flow of the restoration process will now be described with reference to FIG. 27.

FIG. 27 is a sub-flow chart showing an example of the detailed flow of the restoration process of step S9 shown in FIG. 26. In the restoration process, first, in step S21, the processor 81 determines whether the restoration process of step S9 of the current iteration is the process of the first iteration. Here, in the present embodiment, when the restoration condition is satisfied, the process of step S9 is repeatedly executed over a plurality of frames (e.g., while the process loop of steps S3 to S12 is repeated a plurality of times), thus executing the restoration process corresponding to the restoration condition. The determination process of step S21 is the process of determining whether the current iteration of the process of step S9 is the first iteration of the process that is executed repeatedly over a plurality of frames, and is the process of determining whether the restoration process for a certain restorable object has just started. If the determination result from step S21 is affirmative, the process of step S22 is executed. On the other hand, if the determination result from step S21 is negative, the process of step S23 is executed.

In step S22, the processor 81 sets the restoration region data related to the restoration region used for the restoration process. The content represented by the restoration region data (specifically, the path and size) is set according to the method described in “[2-3. Restoration of voxel object]” above. The processor 81 stores, in the DRAM 85, the restoration region data representing the path and size of the restoration region as well as the current state thereof (e.g., the state at the start of the restoration process). The process of step S24 to be described below is executed, following step S22.

In step S23, the processor 81 moves the restoration region along the path. That is, the processor 81 moves the restoration region along the path set for the restoration region by a certain distance equivalent to one frame time. In this process, the processor 81 updates the restoration region data stored in the DRAM 85 to represent the position after the move. As the restoration region is moved by repeatedly executing the process of step S23, target voxels to be restored are successively designated along the path. The process of step S24 is executed, following step S23.

In step S24, the processor 81 restores the restorable object for target voxels that overlap with the restoration region, from among voxels related to the restorable object. Specifically, the processor 81 refers to the reference data stored in the DRAM 85 and identifies the restoration reference values related to the target voxels. Then, the processor 81 updates the voxel object data stored in the DRAM 85 so that the density value in the voxel data for the target voxel becomes equal to the restoration reference value. The process of step S25 is executed, following step S24.

In step S25, the processor 81 determines whether or not to end the restoration process. Specifically, the processor 81 determines whether the restoration region has moved to the end position. If the determination result from step S25 is affirmative, the process of step S26 is executed. On the other hand, if the determination result from step S25 is negative, the processor 81 ends the restoration process.

In step S26, the processor 81 turns OFF the restoration flag related to the restoration process that has been determined to be ended. That is, the processor 81 updates the flag data of the restoration flag to content indicating OFF. After step S26, the processor 81 ends the restoration process.

Note that the restoration process described above is executed for each restoration condition that is satisfied. That is, when a plurality of restoration flags are ON, the processor 81 executes each of the restoration conditions corresponding to the plurality of restoration flags. Then, as described above, a plurality of restoration processes are executed independently.

Referring back to FIG. 26, the process of step S10 is executed, following the restoration process of step S9. In step S10, the processor 81 generates a mesh for a voxel object. The mesh for the voxel object is generated according to the method described in “[2-2. Mesh]” above. Note that in step S10, the processor 81 does not need to again generate the mesh, which has been generated in the process of step S10 up until the previous iteration, but may again generate the mesh for the voxel data updated in step S5. This allows the mesh of a voxel object to change dynamically in the game. Note that the processor 81 updates the mesh data stored in the DRAM 85 to content that represents the newly generated mesh. The process of step S11 is executed, following step S10.

In step S11, the processor 81 generates a game image representing the game space and displays the game image on the display device. Specifically, the processor 81 generates a game image representing the game space including voxel objects and other objects. Note that the image of a voxel object is generated according to the method described in “[2-2. Mesh]” above using the voxel object data and the mesh data stored in the DRAM 85. The processor 81 displays the generated game image on the display device. Note that in the game, the process of step S11 is repeatedly executed at a rate of once per a predetermined amount of time (e.g., one frame time). The process of step S12 is executed, following step S11.

In step S12, the processor 81 determines whether or not to end the game. For example, the processor 81 determines whether or not an instruction to end the game has been given by the user. If the determination result from step S12 is negative, the process of step S3 is executed again. Thereafter, a series of processes of steps S3 to S12 is executed repeatedly until it is determined in step S12 to end the game. On the other hand, if the determination result from step S12 is affirmative, the processor 81 ends the game process shown in FIG. 26.

### 4. Functions/Effects and Variations of Present Embodiment

As described above, in the embodiment described above, the information processing system (in the embodiment described above, the game system 1) stores voxel data corresponding to a plurality of voxels related to a restorable object in the virtual space (in the embodiment described above, the game space), and reference data that serves as a reference for the restorable object, representing the reference value (in the embodiment described above, the restoration reference value) of a parameter (in the embodiment described above, density) included in the voxel data. The information processing system is configured to include the following units:
a voxel updater configured to, when a change event has occurred for a restorable object, update voxel data related to the restorable object (step S5);
a voxel restorator configured to, when a restoration condition is satisfied for the restorable object for which the change event has occurred, execute a restoration process of gradually changing the restorable object by returning a value of a parameter included in the updated voxel data to a reference value included in reference data (step S9);
a mesh generator configured to generate a mesh for the restorable object based on the voxel data (step S10); and
an image generator configured to generate an image of a virtual space including an image obtained by rendering the mesh of the restorable object so as to output the generated image to a display device (step S11).

Thus, it is possible to gradually restore an object to which a change has been made by the restoration process.

Note that “to return a value of a parameter included in voxel data to a reference value included in reference data” means to include (a) to successively executing, for each voxel, the process of returning values of parameters included in a plurality of voxel data as in the embodiment described above, thereby returning the value of each parameter of the plurality of voxel data to the reference value, and (b) to repeat the process of bringing a value of a parameter included in voxel data closer to the reference value for a plurality of iterations, thereby returning the value of the parameter to the reference value.

Note that although an example where a restorable object is a voxel object has been described in the embodiment described above, a restorable object does not need to be a voxel object in other embodiments. Where a restorable object is an object that is not a voxel object, the game system 1 may execute the restoration process by restoring an object for a range within the restoration region, instead of restoring voxels that overlap with the restoration region. In such a case, the game system 1 may store a shape to be a reference of the restorable object, instead of storing a reference value for each voxel.

In the embodiment described above, the parameter corresponding to the reference value represented by the reference data is density. When a change event occurs for the restorable object, the game system 1 updates the voxel data so as to change the parameter representing density, and when the restoration condition is satisfied, the game system 1 gradually changes the voxel data by returning the value of the parameter representing density included in the voxel data to the reference value included in the reference data. Then, the shape of the restorable object deformed by the occurrence of the change event can be restored by the restoration process.

Here, in other embodiments, the parameter corresponding to the reference value is not limited to density, but may be any parameter representing the state of the restorable object. For example, the reference value may be a reference value (e.g., the material ID) for a material set in a voxel, from among parameters included in the voxel data. Then, when a change event has occurred for the restorable object, the game system 1 updates the voxel data so as to change the parameter indicating the material (e.g., the material ID). When the restoration condition is satisfied, the game system 1 gradually changes the voxel data by returning the value of the parameter representing material included in the voxel data to the reference value included in the reference data. Then, it is possible to, with the restoration process, restore the material of a restorable object whose material has changed (e.g., the property and/or appearance of the restorable object has changed) due to the occurrence of a change event. Then, it is possible to express a restorable object that is set to a lava material changing to a solidified-lava rock material in response to a change event in which the restorable object contacts an ice object, and then returning to a lava material, for example.

Note that, in other embodiments, the game system 1 may change both the density and material of the restorable object in response to a change event, and may return both the density and material parameters to reference values in the restoration process.

In other embodiments, the parameter corresponding to the reference value may be a parameter representing the state of the restorable object. For example, the parameter may be a parameter representing the amount of damage inflicted on the restorable object. Moreover, the game system 1 may change the appearance (e.g., the texture) of the restorable object depending on the parameter. Then, the game system 1 may change the appearance of the restorable object in response to the occurrence of a change event, and restore the appearance of the restorable object in response to the satisfaction of the restoration condition.

Note that in other embodiments, the information processing system does not need to include one or more of the components of the embodiment described above and does not need to execute one or more of the processes that are executed in the embodiment described above. For example, in order to realize a specific one of the advantageous effects of the embodiment described above, the information processing system may include a component or components for realizing the specific advantageous effect and execute a process or processes for realizing the specific advantageous effect, and the information processing system does not need to include other components and does not need to execute other processes.

The embodiment described above can be used as, for example, a game system and a game program, with the aim of, for example, gradually restoring an object to which a change has been made.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. One or more non-transitory computer-readable storage medium having stored therein instructions that, when executed, cause one or more processors of an information processing apparatus to execute information processing, wherein:
the information processing apparatus stores voxel data related to a plurality of voxels related to a restorable object in a virtual space, and reference data that serves as a reference for the restorable object, representing a reference value of a parameter included in the voxel data, and
the information processing comprising:
when a change event has occurred for the restorable object, updating the voxel data related to the restorable object;
when a restoration condition is satisfied for the restorable object for which the change event has occurred, executing a restoration process of gradually changing the restorable object by returning a value of a parameter included in a plurality of voxel data having been updated to the reference value included in the reference data;
generating a mesh for the restorable object based on the voxel data; and
generating an image of the virtual space including an image obtained by rendering the mesh of the restorable object so as to output the generated image to a display device.

2. The non-transitory computer-readable storage medium according to claim 1, wherein the restoration process is executed when it is determined that the restoration condition is satisfied at a second timing subsequent to a first timing, the second timing being determined based on the first timing at which the change event has occurred.

3. The non-transitory computer-readable storage medium according to claim 2, wherein:
the change event is that a player object is arranged on the restorable object in the virtual space; and
when the change event occurs, the voxel data is updated so as to remove a portion of the restorable object that includes a position at which the player object is arranged.

4. The non-transitory computer-readable storage medium according to claim 1, wherein the restoration process is executed when it is determined that the restoration condition is satisfied in response to an operation by a player.

5. The non-transitory computer-readable storage medium according to claim 1, wherein the reference data represents the reference value for each of a plurality of voxels related to the restorable object.

6. The non-transitory computer-readable storage medium according to claim 1, wherein target voxels to be restored from among the voxels related to the restorable object are successively designated based on a designation rule so as to restore the designated voxels.

7. The non-transitory computer-readable storage medium according to claim 6, wherein the target voxels are successively designated along a restoration path set in the virtual space.

8. The non-transitory computer-readable storage medium according to claim 7, wherein:
the change event is that a breaker object contacting the restorable object in the virtual space;
when the change event occurs, the voxel data is updated so as to remove a portion of the restorable object that includes a position at which the breaker object made contact; and
the restoration path is set, based on a position at which the breaker object contacted the restorable object, so as to extend in a direction in accordance with a contact direction.

9. The non-transitory computer-readable storage medium according to claim 7, wherein:
when a first restoration condition is satisfied for a portion of the restorable object for which a first change event has occurred as the change event, the target voxels are successively designated based on first restoration region data defining the restoration path for a first restoration process, which is the restoration process corresponding to the first change event;
when a second restoration condition is satisfied for a portion of the restorable object for which a second change event, different from the first change event, has occurred as the change event, the target voxels are successively designated based on second restoration region data defining the restoration path for a second restoration process, which is the restoration process corresponding to the second change event; and
during an overlapping period between a period in which the first restoration process is executed and a period in which the second restoration process is executed, restoration is done for voxels, as the target voxels, that are designated based on at least one of the first restoration region data and the second restoration region data.

10. The non-transitory computer-readable storage medium according to claim 7, wherein
a restoration region is set in the virtual space;
the target voxels are designated from among those of the plurality of voxels related to the restorable object that overlap with the restoration region; and
the target voxels are successively designated by moving the restoration region along the restoration path.

11. The non-transitory computer-readable storage medium according to claim 6, wherein the target voxels are successively designated in a direction from inside to outside of the restorable object.

12. The non-transitory computer-readable storage medium according to claim 1, wherein:
the reference data represents a reference value of a parameter representing density to be used for generating the mesh from among parameters included in the voxel data;
when the change event occurs for the restorable object, the voxel data is updated so as to change the parameter representing density; and
when a restoration condition is satisfied for the restorable object for which the change event has occurred, the restoration process of gradually changing the restorable object is executed by returning a value of the parameter representing density included in the voxel data having been updated to the reference value included in the reference data.

13. The non-transitory computer-readable storage medium according to claim 1, wherein:
the reference data represents a reference value for a material set for the voxel from among parameters included in the voxel data;
when the change event occurs for the restorable object, the voxel data is updated so as to change the parameter representing material; and
when the restoration condition is satisfied for the restorable object for which the change event has occurred, the restoration process of gradually changing the restorable object is executed by returning a value of the parameter representing material included in the voxel data having been updated to the reference value included in the reference data.

14. The non-transitory computer-readable storage medium according to claim 1, wherein when the change event occurs for the restorable object, the voxel data related to the restorable object is updated so as to reduce a range of the virtual space occupied by the restorable object.

15. The non-transitory computer-readable storage medium according to claim 14, wherein:
when the change event occurs for the restorable object, the range of the virtual space occupied by the restorable object is reduced, and a separated object corresponding to the reduced portion is generated; and
when the restoration condition is satisfied for the restorable object, the restoration process is executed for the restorable object while the restoration process is not executed for the separated object.

16. The non-transitory computer-readable storage medium according to claim 1, wherein when the change event occurs for the restorable object, the voxel data related to the restorable object is updated so as to increase the range of the virtual space occupied by the restorable object.

17. The non-transitory computer-readable storage medium according to claim 1, wherein:
the information processing further comprises: moving and/or rotating the restorable object in the virtual space by moving and/or rotating a voxel space where the voxel related to the restorable object is set in the virtual space; and
when the restorable object is moved and/or rotated after the change event, the restoration process is executed using the voxel data related to the voxel space after the movement and/or rotation.

18. An information processing apparatus, comprising:
one or more processors that are configured to execute information processing: and
one or more memory that are configured to store voxel data related to a plurality of voxels related to a restorable object in a virtual space, and reference data that serves as a reference for the restorable object, representing a reference value of a parameter included in the voxel data; wherein
the information processing comprising:
when a change event has occurred for the restorable object, updating the voxel data related to the restorable object;
when a restoration condition is satisfied for the restorable object for which the change event has occurred, executing a restoration process of gradually changing the restorable object by returning a value of a parameter included in a plurality of voxel data having been updated to the reference value included in the reference data;
generating a mesh for the restorable object based on the voxel data; and
generating an image of the virtual space including an image obtained by rendering the mesh of the restorable object so as to output the generated image to a display device.

19. An information processing system, comprising:
one or more processors that are configured to execute information processing: and
one or more memory that are configured to store voxel data related to a plurality of voxels related to a restorable object in a virtual space, and reference data that serves as a reference for the restorable object, representing a reference value of a parameter included in the voxel data; wherein
the information processing comprising:
when a change event has occurred for the restorable object, updating the voxel data related to the restorable object;
when a restoration condition is satisfied for the restorable object for which the change event has occurred, executing a restoration process of gradually changing the restorable object by returning a value of a parameter included in a plurality of voxel data having been updated to the reference value included in the reference data;
generating a mesh for the restorable object based on the voxel data; and
generating an image of the virtual space including an image obtained by rendering the mesh of the restorable object so as to output the generated image to a display device.

20. An information processing method performed on an information processing system, the information processing method comprising:
storing voxel data related to a plurality of voxels related to a restorable object in a virtual space, and reference data that serves as a reference for the restorable object, representing a reference value of a parameter included in the voxel data;
when a change event has occurred for the restorable object, updating the voxel data related to the restorable object;
when a restoration condition is satisfied for the restorable object for which the change event has occurred, executing a restoration process of gradually changing the restorable object by returning a value of a parameter included in a plurality of voxel data having been updated to the reference value included in the reference data;
generating a mesh for the restorable object based on the voxel data; and
generating an image of the virtual space including an image obtained by rendering the mesh of the restorable object so as to output the generated image to a display device.
